(19) United States
(12) Patent Application Publication
(10) Pub. No.: US 2025/0184632 A1
(43) Pub. Date: Jun. 5, 2025

(54) SOLID-STATE IMAGING ELEMENT, IMAGING DEVICE, AND METHOD FOR CONTROLLING SOLID-STATE IMAGING ELEMENT

(71) Applicant: SONY SEMICONDUCTOR SOLUTIONS CORPORATION, KANAGAWA (JP)

(72) Inventor: TOMOYUKI SHIZU, KANAGAWA (JP)

(21) Appl. No.: 18/842,207

(22) PCT Filed: Jan. 10, 2023
(86) PCT No.: PCT/JP2023/000304

§ 371 Date: Aug. 28, 2024

(30) Foreign Application Priority Data
Mar. 7, 2022 (JP) 2022-034417

(51) Int. Cl. H04N 25/51; H04N 25/531; H04N 25/532; H04N 25/78

(52) U.S. Cl. CPC H04N 25/51; H04N 25/531; H04N 25/532; H04N 25/78

(57) ABSTRACT

Loss of an imaging opportunity is to be prevented in a solid-state imaging element that captures a plurality of pieces of image data. The solid-state imaging element includes a pre-stage circuit, a sample-and-hold circuit, an amplifier circuit, and a timing control circuit. The pre-stage circuit generates a pixel signal. The sample-and-hold circuit holds the pixel signal over a predetermined holding period, and outputs the pixel signal a plurality of times within the holding period. The amplifier circuit amplifies the pixel signal with a gain designated by a predetermined control signal among a plurality of gains. The timing control circuit sequentially designates the plurality of gains with the control signal within the holding period.

### TECHNICAL FIELD

The present technology relates to a solid-state imaging element. More particularly, the present technology relates to a solid-state imaging element that switches gains, an imaging device, and a method for controlling the solid-state imaging element.

### BACKGROUND ART

As a complementary MOS (CMOS) semiconductor manufacturing process can be used, CMOS image sensors (CISs) that are solid-state imaging elements using CMOSs have been widely used in imaging devices and the like. For example, there is a proposed CIS that captures and displays a plurality of pieces of image data having different exposure start timings and exposure times, and allows a user to select desired image data (see Patent Document 1, for example).

### CITATION LIST

### Patent Document

Patent Document 1: Japanese Patent Application Laid-Open No. 2020-31255

### SUMMARY OF THE INVENTION

### Problems to be Solved by the Invention

By the above-described conventional technique, imaging is performed a plurality of times at different exposure start timings and different exposure times, so that pieces of image data that vary in the degree of motion blur and brightness is generated when the subject moves. In the above-described solid-state imaging element, however, the exposure start timings and the exposure end timings are the same, and a plurality of pieces of image data that vary in brightness cannot be captured. To capture pieces of image data that vary in brightness with the above-described solid-state imaging element, it is necessary to change the exposure start timing, and there is a possibility that an imaging opportunity will be missed at that time.

The present technology has been developed in view of such circumstances, and aims to prevent loss of an imaging opportunity in a solid-state imaging element that captures a plurality of pieces of image data.

### Solutions to Problems

The present technology has been developed to solve the above problems, and a first aspect thereof is a solid-state imaging element that includes: a pre-stage circuit that generates a pixel signal; a sample-and-hold circuit that holds the pixel signal over a predetermined holding period, and outputs the pixel signal a plurality of times within the holding period; an amplifier circuit that amplifies the pixel signal with a gain designated by a predetermined control signal among a plurality of gains; and a timing control circuit that sequentially designates the plurality of gains with the control signal within the holding period, and a method for controlling the solid-state imaging element. This brings about an effect to generate a plurality of pieces of image data having different brightnesses by one exposure operation.

Furthermore, in the first aspect, the amplifier circuit may be a comparator that compares the pixel signal with a predetermined ramp signal. This brings about an effect to amplify an analog pixel signal.

Also, in the first aspect, the pre-stage circuit and the sample-and-hold circuit may be disposed in a pixel, and the comparator may include: a differential amplifier circuit that amplifies a difference between a predetermined reference voltage and a voltage of a predetermined node, and outputs the difference as a comparison result; a vertical-signal-line-side capacitor that is inserted between the predetermined node and a vertical scanning line to which the pixel is connected; a ramp-side capacitor that is inserted between the predetermined node and a digital-to-analog converter that generates the ramp signal; and a switch that changes a capacitance ratio between the vertical-signal-line-side capacitor and the ramp-side capacitor, in accordance with the control signal. This brings about an effect to switch analog gains by changing the capacitance ratio.

Furthermore, in the first aspect, a digital-to-analog converter that generates the ramp signal in accordance with the control signal may be further included, and the timing control circuit may change the velocity at which the level of the ramp signal fluctuates, using the control signal. This brings about an effect to switch analog gains by changing the fluctuation velocity of the ramp signal.

Also, in the first aspect, an analog-to-digital converter that performs an analog-to-digital conversion process on the pixel signal may be further included, and the amplifier circuit may be a column amplifier that supplies the amplified pixel signal to the analog-to-digital converter. This brings about an effect to amplify an analog pixel signal.

Furthermore, in the first aspect, a post-stage circuit that supplies the pixel signal to a vertical signal line may be further included, and the amplifier circuit may supply the amplified pixel signal to the post-stage circuit. This brings about an effect to amplify a pixel signal in a pixel.

Also, in the first aspect, an analog-to-digital converter that performs an analog-to-digital conversion process on the pixel signal may be further included, and the amplifier circuit may amplify the pixel signal subjected to the analog-to-digital conversion process. This brings about an effect to amplify a digital pixel signal.

Furthermore, in the first aspect, a post-stage reset transistor may be further included, the sample-and-hold circuit may include: first and second capacitor elements; and a selection circuit that sequentially performs control to connect one of the first and second capacitor elements to a predetermined post-stage node, control to disconnect both the first and second capacitor elements from the post-stage node, and control to connect the other one of the first and second capacitor elements to the post-stage node, and the post-stage reset transistor may initialize the level of the post-stage node when both the first and second capacitor elements are disconnected from the post-stage node. This brings about an effect to reduce noise.

Further, a second aspect of the present technology is an imaging device that includes: a pre-stage circuit that generates a pixel signal; a sample-and-hold circuit that holds the pixel signal over a predetermined holding period, and outputs the pixel signal a plurality of times within the holding period; an amplifier circuit that amplifies the pixel signal with a gain designated by a predetermined control signal among a plurality of gains; a timing control circuit that sequentially designates the plurality of gains with the control signal within the holding period; and a digital signal processing circuit that processes image data in which the pixel signals are arrayed. This brings about an effect to generate a plurality of pieces of image data having different brightnesses by one exposure operation, and process the image data.

Also, in the second aspect, a set value holding unit that holds the value of one gain of the plurality of gains as a set value in accordance with an operation by a user may be further included, and the amplifier circuit may amplify the pixel signal with a gain of the set value. This brings about an effect to enhance user-friendliness of the imaging device.

Furthermore, in the second aspect, the digital signal processing circuit may perform machine learning using a predetermined number of pieces of the image data. This brings about an effect to reduce the number of exposure operations required for generating a data set.

### BRIEF DESCRIPTION OF DRAWINGS

FIG. 1 is a block diagram illustrating an example configuration of an imaging device according to a first embodiment of the present technology.

FIG. 2 is a block diagram illustrating an example configuration of a solid-state imaging element according to the first embodiment of the present technology.

FIG. 3 is a circuit diagram illustrating an example configuration of a pixel according to the first embodiment of the present technology.

FIG. 4 is a block diagram illustrating an example configuration of a load MOS circuit block and a column signal processing circuit according to the first embodiment of the present technology.

FIG. 5 is a circuit diagram illustrating an example configuration of a comparator unit according to the first embodiment of the present technology.

FIG. 6 is a diagram for explaining an operation of the solid-state imaging element at a time of imaging according to the first embodiment of the present technology.

FIG. 7 is a block diagram illustrating an example configuration of a column signal processing circuit to which column amplifiers are added according to the first embodiment of the present technology.

FIG. 8 is a circuit diagram illustrating another example configuration of a pixel according to the first embodiment of the present technology.

FIG. 9 is a timing chart illustrating an example of an operation of the solid-state imaging element according to the first embodiment of the present technology.

FIG. 10 is a timing chart illustrating an example of a global shutter operation according to the first embodiment of the present technology.

FIG. 11 is a timing chart illustrating an example of a read operation according to the first embodiment of the present technology.

FIG. 12 is a timing chart illustrating an example of an operation of a solid-state imaging element according to a comparative example.

FIG. 13 is a diagram illustrating an example of image data according to the first embodiment of the present technology.

FIG. 14 is a diagram illustrating an example of image data according to a comparative example.

FIG. 15 is a flowchart illustrating an example of an operation of the imaging device according to the first embodiment of the present technology.

FIG. 16 is a block diagram illustrating an example configuration of a solid-state imaging element according to a first modification of the first embodiment of the present technology.

FIG. 17 is a flowchart illustrating an example operation of an imaging device according to the first modification of the first embodiment of the present technology.

FIG. 18 is a block diagram illustrating an example configuration of a DSP circuit according to a second modification of the first embodiment of the present technology.

FIG. 19 is a circuit diagram illustrating an example configuration of a pixel according to a second embodiment of the present technology.

FIG. 20 is a block diagram illustrating an example configuration of a column signal processing circuit according to a third embodiment of the present technology.

FIG. 21 is a circuit diagram illustrating an example configuration of a pixel according to a fourth embodiment of the present technology.

FIG. 22 is a timing chart illustrating an example of a global shutter operation according to the fourth embodiment of the present technology.

FIG. 23 is a timing chart illustrating an example of a read operation according to the fourth embodiment of the present technology.

FIG. 24 is a diagram illustrating an example of the stack structure of a solid-state imaging element according to a first modification of the fourth embodiment of the present technology.

FIG. 25 is a circuit diagram illustrating an example configuration of a pixel according to the first modification of the fourth embodiment of the present technology.

FIG. 26 is a diagram illustrating an example of the stack structure of a solid-state imaging element according to a second modification example of the fourth embodiment of the present technology.

FIG. 27 is a circuit diagram illustrating an example configuration of a pixel according to a fifth embodiment of the present technology.

FIG. 28 is a timing chart illustrating an example of a global shutter operation according to the fifth embodiment of the present technology.

FIG. 29 is a circuit diagram illustrating an example configuration of a pixel according to a sixth embodiment of the present technology.

FIG. 30 is a diagram for explaining reset feedthrough in the sixth embodiment of the present technology.

FIG. 31 is a diagram for explaining variations in level caused by reset feedthrough in the sixth embodiment of the present technology.

FIG. 32 is a timing chart illustrating an example of voltage control according to the sixth embodiment of the present technology.

FIG. 33 is a timing chart illustrating an example of a global shutter operation for odd-numbered frames according to a seventh embodiment of the present technology.

FIG. 34 is a timing chart illustrating an example of a read operation for odd-numbered frames according to the seventh embodiment of the present technology.

FIG. 35 is a timing chart illustrating an example of a global shutter operation for even-numbered frames according to the seventh embodiment of the present technology.

FIG. 36 is a timing chart illustrating an example of a read operation for even-numbered frames according to the seventh embodiment of the present technology.

FIG. 37 is a circuit diagram illustrating an example configuration of a column signal processing circuit according to an eighth embodiment of the present technology.

FIG. 38 is a timing chart illustrating an example of a global shutter operation according to the eighth embodiment of the present technology.

FIG. 39 is a timing chart illustrating an example of a read operation according to the eighth embodiment of the present technology.

FIG. 40 is a timing chart illustrating an example of a rolling shutter operation according to a ninth embodiment of the present technology.

FIG. 41 is a block diagram illustrating an example configuration of a solid-state imaging element according to a tenth embodiment of the present technology.

FIG. 42 is a circuit diagram illustrating an example configuration of a dummy pixel, a regulator, and a switching unit according to the tenth embodiment of the present technology.

FIG. 43 is a timing chart illustrating an example of operations of the dummy pixels and the regulator according to the tenth embodiment of the present technology.

FIG. 44 is a circuit diagram illustrating an example configuration of an effective pixel according to the tenth embodiment of the present technology.

FIG. 45 is a timing chart illustrating an example of a global shutter operation according to the tenth embodiment of the present technology.

FIG. 46 is a timing chart illustrating an example of a read operation according to the tenth embodiment of the present technology.

FIG. 47 is a table for explaining the effects in the tenth embodiment of the present technology.

FIG. 48 is a block diagram illustrating an example of a schematic configuration of a vehicle control system.

FIG. 49 is an explanatory diagram illustrating an example of the installation positions of imaging sections.

### MODE FOR CARRYING OUT THE INVENTION

Modes for carrying out the present technology (hereinafter referred to as embodiments) will be described below. The description will be given in the following order.
1. First embodiment (an example in which gains are switched within a holding period)
2. Second embodiment (an example in which an amplifier circuit is disposed in a pixel, and gains are switched within a holding period)
3. Third embodiment (an example in which digital gains are switched within a holding period)
4. Fourth embodiment (an example in which the pre-stage circuit can be detached from the pre-stage node, and gains are switched within a holding period)
5. Fifth embodiment (an example in which a discharge transistor is added, and gains are switched within a holding period)
6. Sixth embodiment (an example in which gains are switched within a holding period, and the reset power supply voltage is controlled)
7. Seventh embodiment (an example in which gains are switched within a holding period, and the levels to be held are reversed for each frame)
8. Eighth embodiment (an example in which gains are switched within a holding period, and a black spot phenomenon is prevented)
9. Ninth embodiment (an example in which a rolling shutter operation is performed)
10. Tenth embodiment (an example in which gains are switched within a holding period, and the source follower is put into an off-state at a time of reading)
11. Example applications to mobile objects

### 1. First Embodiment

### [Example Configuration of an Imaging Device]

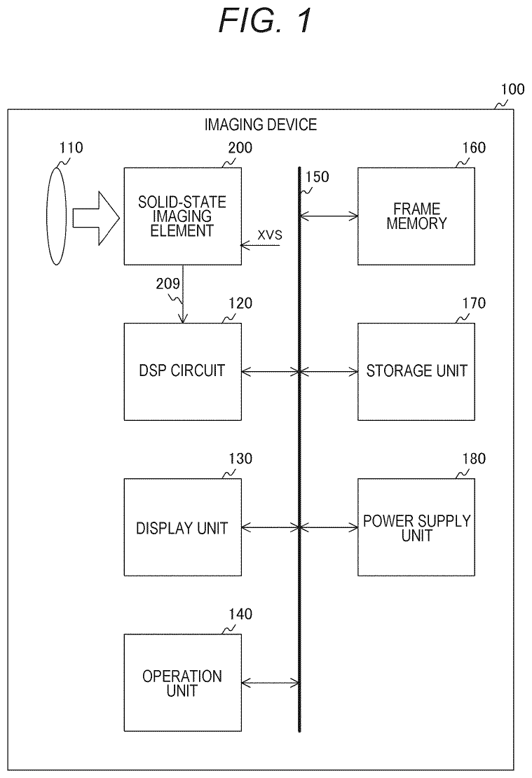

FIG. 1 is a block diagram illustrating an example configuration of an imaging device 100 in a first embodiment of the present technology. The imaging device 100 is a device for imaging image data, and includes an optical unit 110, a solid-state imaging element 200, and a digital signal processing (DSP) circuit 120. The imaging device 100 further includes a display unit 130, an operation unit 140, a bus 150, a frame memory 160, a storage unit 170, and a power supply unit 180. As the imaging device 100, a digital camera, or an electronic device (a smartphone, a personal computer, or the like) having an imaging function is assumed.

The optical unit 110 condenses light from the subject, and guides the light to the solid-state imaging element 200. The solid-state imaging element 200 generates image data by photoelectric conversion. The solid-state imaging element 200 generates image data, and supplies the image data to the DSP circuit 120 via a signal line 209.

The DSP circuit 120 performs predetermined signal processing on the image data. The DSP circuit 120 outputs the processed image data to the frame memory 160 or the like via the bus 150. Note that the DSP circuit 120 is an example of the digital signal processing circuit disclosed in the claims.

The display unit 130 displays the image data. The display unit 130 is assumed to be a liquid crystal panel or an organic electro luminescence (EL) panel, for example. The operation unit 140 generates an operation signal in accordance with a user's operation.

The bus 150 is a common path through which the optical unit 110, the solid-state imaging element 200, the DSP circuit 120, the display unit 130, the operation unit 140, the frame memory 160, the storage unit 170, and the power supply unit 180 exchange data with each other.

The frame memory 160 holds image data. The storage unit 170 stores various kinds of data such as image data. The power supply unit 180 supplies power to the solid-state imaging element 200, the DSP circuit 120, the display unit 130 and the like.

### [Example Configuration of a Solid-State Imaging Element]

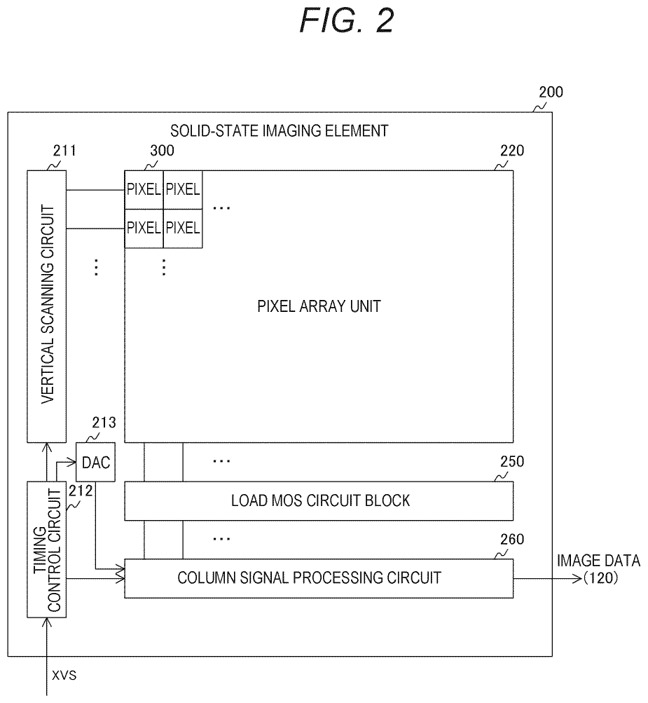

FIG. 2 is a block diagram illustrating an example configuration of the solid-state imaging element 200 according to the first embodiment of the present technology. The solid-state imaging element 200 includes a vertical scanning circuit 211, a pixel array unit 220, a timing control circuit 212, a digital to analog converter (DAC) 213, a load MOS circuit block 250, and a column signal processing circuit 260. In the pixel array unit 220, a plurality of pixels 300 is arranged in a two-dimensional grid pattern. Furthermore, each circuit in the solid-state imaging element 200 is disposed in a single semiconductor chip, for example.

Hereinafter, a set of pixels 300 arranged in a horizontal direction will be referred to as a “row”, and a set of pixels 300 arranged in a direction perpendicular to a row will be referred to as a “column”.

The timing control circuit 212 controls operation timing of each of the vertical scanning circuit 211, the DAC 213, and the column signal processing circuit 260 in synchronization with a vertical synchronization signal XVS.

The DAC 213 generates a sawtooth ramp signal by digital to analog (DA) conversion. The DAC 213 supplies the generated ramp signal to the column signal processing circuit 260.

The vertical scanning circuit 211 sequentially selects and drives rows to output analog pixel signals. The pixel 300 photoelectrically converts incident light, to generate an analog pixel signal. This pixel 300 supplies the pixel signal to the column signal processing circuit 260 via the load MOS circuit block 250.

In the load MOS circuit block 250, a MOS transistor that supplies a constant current is provided for each column.

The column signal processing circuit 260 performs signal processing such as an analog to digital (AD) conversion process and a correlated double sampling (CDS) process on a pixel signal for each column. The column signal processing circuit 260 supplies the image data including the processed signals to the DSP circuit 120.

### [Example Configuration of a Pixel]

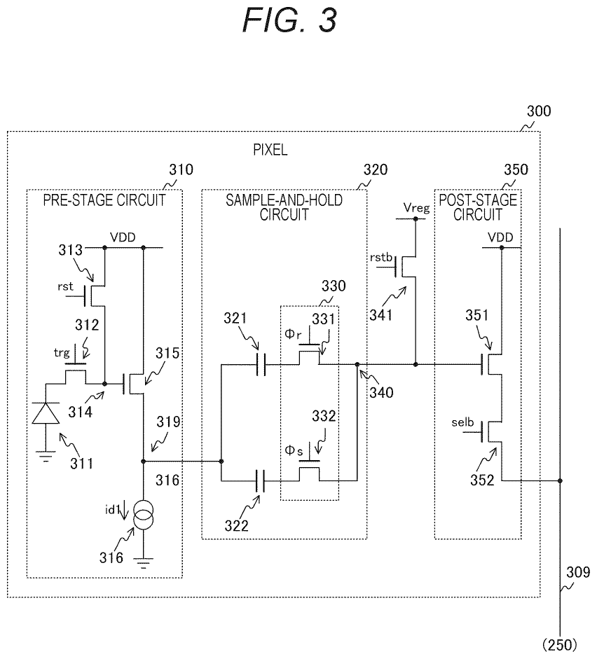

FIG. 3 is a circuit diagram illustrating an example configuration of a pixel 300 according to the first embodiment of the present technology. The pixel 300 includes a pre-stage circuit 310, a sample-and-hold circuit 320, a post-stage reset transistor 341, and a post-stage circuit 350.

The pre-stage circuit 310 includes a photoelectric conversion element 311, a transfer transistor 312, a floating diffusion (FD) reset transistor 313, an FD 314, a pre-stage amplification transistor 315, and a current source transistor 316.

The photoelectric conversion element 311 generates electric charge by photoelectric conversion. The transfer transistor 312 transfers the electric charge from the photoelectric conversion element 311 to the FD 314, in accordance with a transfer signal trg from the vertical scanning circuit 211.

The FD reset transistor 313 extracts the electric charge from the FD 314 to initialize the FD 314, in accordance with an FD reset signal rst from the vertical scanning circuit 211. The FD 314 accumulates electric charge, and generates a voltage corresponding to the charge amount. The pre-stage amplification transistor 315 amplifies the level of the voltage of the FD 314, and outputs the amplified voltage to a pre-stage node 319.

Furthermore, the FD reset transistor 313 and the pre-stage amplification transistor 315 have their respective sources connected to a power supply voltage VDD. The current source transistor 316 is connected to the drain of the pre-stage amplification transistor 315. The current source transistor 316 supplies a current id1, under the control of the vertical scanning circuit 211.

The sample-and-hold circuit 320 samples and holds pixel signals. The sample-and-hold circuit 320 includes capacitor elements 321 and 322, and a selection circuit 330.

The capacitor elements 321 and 322 each have one end commonly connected to the pre-stage node 319, and have the other end connected to the selection circuit 330. Note that the capacitor elements 321 and 322 are an example of the first and second capacitor elements disclosed in the claims.

The selection circuit 330 includes a selection transistor 331 and a selection transistor 332. The selection transistor 331 opens and closes a path between the capacitor element 321 and a post-stage node 340, in accordance with a selection signal or from the vertical scanning circuit 211. The selection transistor 332 opens and closes a path between the capacitor element 322 and the post-stage node 340, in accordance with a selection signal Φs from the vertical scanning circuit 211.

The post-stage reset transistor 341 initializes the level of the post-stage node 340 to a predetermined potential Vreg, in accordance with a post-stage reset signal rstb from the vertical scanning circuit 211. A potential different from the power supply voltage VDD (a potential lower than VDD, for example) is set as the potential Vreg.

The post-stage circuit 350 includes a post-stage amplification transistor 351, and a post-stage selection transistor 352. The post-stage amplification transistor 351 amplifies the level of the post-stage node 340. The post-stage selection transistor 352 outputs a signal at the level amplified by the post-stage amplification transistor 351 as a pixel signal to a vertical signal line 309, in accordance with a post-stage selection signal selb from the vertical scanning circuit 211.

Note that n-channel metal oxide semiconductor (nMOS) transistors are used as the various transistors (such as the transfer transistor 312) in the pixel 300, for example.

The vertical scanning circuit 211 supplies a high-level FD reset signal rst and a high-level transfer signal trg to all the pixels at the start of exposure. Thus, the photoelectric conversion element 311 is initialized. Hereinafter, this control will be referred to as the “PD reset”.

The vertical scanning circuit 211 then supplies the high-level FD reset signal rst over a pulse period, while setting the post-stage reset signal rstb and the selection signal or to the high level for all the pixels, immediately before the end of the exposure. Thus, the FD 314 is initialized, and the level corresponding to the level of the FD 314 at that time is held in the capacitor element 321. This control will be hereinafter referred to as the “FD reset”.

The level of the FD 314 at the time of the FD reset and the level corresponding to the level of the FD 314 (the level held in the capacitor element 321 and the level of the vertical signal line 309) will be hereinafter collectively referred to as the “P-phase” or the “reset level”.

At the end of the exposure, the vertical scanning circuit 211 supplies the high-level transfer signal trg over the pulse period, while setting the post-stage reset signal rstb and the selection signal Φs to the high level for all the pixels. As a result, signal charge corresponding to the exposure amount is transferred to the FD 314, and the level corresponding to the level of the FD 314 at that time is held in the capacitor element 322.

The level of the FD 314 at the time of the signal charge transfer and the level corresponding to the level of the FD 314 (the level held in the capacitor element 322 and the level of the vertical signal line 309) will be hereinafter collectively referred to as the “D-phase” or the “signal level”.

The exposure control to simultaneously start and end exposure for all the pixels in this manner is called the global shutter method. By this exposure control, the pre-stage circuits 310 of all the pixels sequentially generate the reset level and the signal level. The reset level is held in the capacitor element 321, and the signal level is held in the capacitor element 322.

After the end of the exposure, the vertical scanning circuit 211 sequentially selects a row, and sequentially outputs the reset level and the signal level of the row. When the reset level is to be output, the vertical scanning circuit 211 supplies a high-level selection signal or over a predetermined period, while setting the FD reset signal rst and the post-stage selection signal selb of the selected row to the high level. As a result, the capacitor element 321 is connected to the post-stage node 340, and the reset level is read.

After the reset level is read, the vertical scanning circuit 211 supplies a high-level post-stage reset signal rstb over the pulse period, while keeping the FD reset signal rst and the post-stage selection signal selb of the selected row at the high level. Thus, the level of the post-stage node 340 is initialized. At this point of time, both the selection transistor 331 and the selection transistor 332 are in an open state, and the capacitor elements 321 and 322 are disconnected from the post-stage node 340.

After the initialization of the post-stage node 340, the vertical scanning circuit 211 supplies a high-level selection signal Φs over a predetermined period, while keeping the FD reset signal rst and the post-stage selection signal selb of the selected row at the high level. As a result, the capacitor element 322 is connected to the post-stage node 340, and the signal level is read.

Here, one mode of a plurality of modes including a normal mode and a gain switching mode is set in the solid-state imaging element 200. The normal mode is a mode in which one piece of image data is generated by one exposure operation. On the other hand, the gain switching mode is a mode in which a plurality of pieces of image data that varies in brightness is generated by switching gains in one exposure operation. Each mode is manually set in accordance with a user operation. Alternatively, each mode is automatically set, under the control of the DSP circuit 120 or the like.

In a case where the normal mode is set, the sample-and-hold circuit 320 outputs each of the reset level and the signal level of a pixel signal once within a holding period that is the period for holding the pixel signal.

In a case where the gain switching mode is set, on the other hand, the sample-and-hold circuit 320 outputs a pixel signal (the reset level and the signal level) a plurality of times within the holding period. The plurality of output reset levels is amplified with different gains by a circuit of a subsequent stage. Further, the plurality of output signal levels is also amplified with different gains.

### [Example Configuration of a Column Signal Processing Circuit]

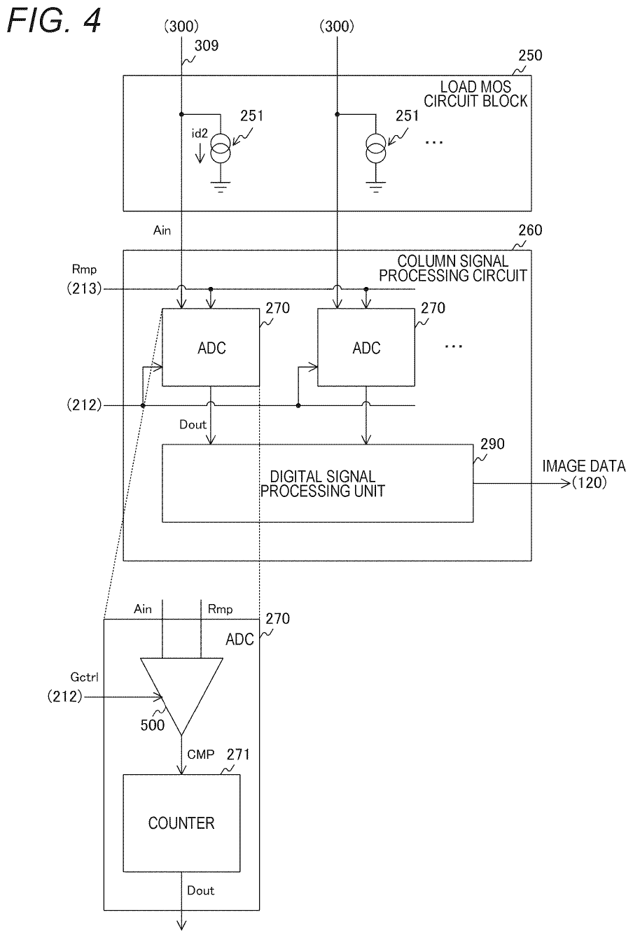

FIG. 4 is a block diagram illustrating an example configuration of the load MOS circuit block 250 and the column signal processing circuit 260 according to the first embodiment of the present technology.

In the load MOS circuit block 250, the vertical signal lines 309 are wired for the respective columns. Where the number of columns is I (I being an integer), I vertical signal lines 309 are wired. Furthermore, a load MOS transistor 251 that supplies a constant current id2 is connected to each of the vertical signal lines 309.

In the column signal processing circuit 260, a plurality of ADCs 270 and a digital signal processing unit 290 are disposed. The ADCs 270 are provided for the respective columns. Where the number of columns is I, I ADCs 270 are disposed.

Each ADC 270 performs an AD conversion process on an analog pixel signal Ain from the corresponding column, using a ramp signal Rmp from the DAC 213. The ADC 270 supplies a pixel signal Dout subjected to the AD conversion, to the digital signal processing unit 290. For example, a single-slope ADC including a comparator 500 and a counter 271 is provided as the ADC 270.

The comparator 500 compares the pixel signal Ain with the ramp signal Rmp, and supplies a comparison result CMP to the counter 271. Also, this comparator 500 can amplify the pixel signal Ain with an analog gain. This analog gain is variable, and one gain of a plurality of gains is designated by a control signal Gctrl from the timing control circuit 212. Note that the comparator 500 is an example of the amplifier circuit disclosed in the claims.

The counter 271 counts a count value over the period until the comparison result CMP is inverted. This counter 271 outputs a digital signal indicating the count value as the pixel signal Dout to the digital signal processing unit 290.

The digital signal processing unit 290 performs predetermined signal processing such as CDS processing on the pixel signal (digital signal) for each column. The digital signal processing unit 290 supplies image data in which the processed digital signals are arrayed, to the DSP circuit 120.

### [Example Configuration of a Comparator]

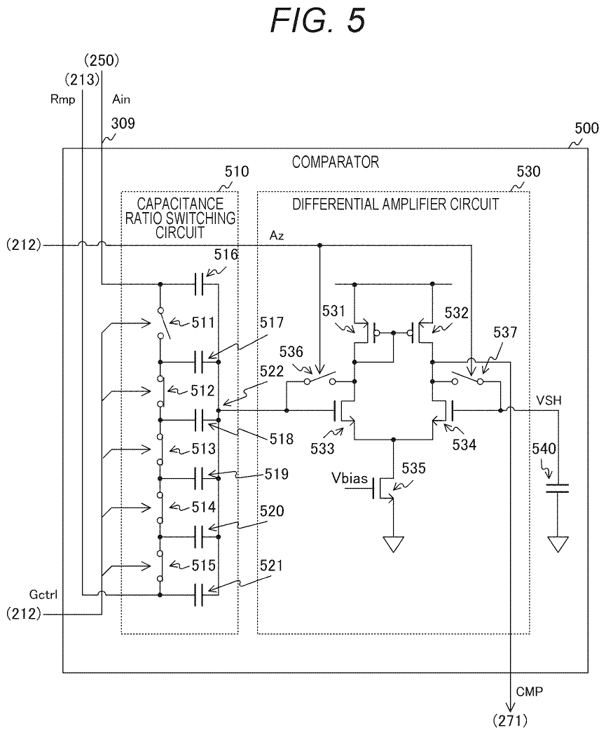

FIG. 5 is a circuit diagram illustrating an example configuration of a comparator 500 according to the first embodiment of the present technology. In the comparator 500, a capacitance ratio switching circuit 510 and a differential amplifier circuit 530 are disposed. The capacitance ratio switching circuit 510 includes a predetermined number of switches such as switches 511 to 515, and a plurality of capacitors such as the capacitors 516 to 521.

One end of each of the capacitors 516 to 521 is commonly connected to a node 522. The other end of the capacitor 516 is connected to the load MOS circuit block 250 via the signal line 309, and the other end of the capacitor 521 is connected to the DAC 213.

The switch 511 opens and closes a path between the other end of the capacitor 516 and the other end of the capacitor 517, in accordance with the control signal Gctrl. The switch 512 opens and closes a path between the other end of the capacitor 517 and the other end of the capacitor 518, in accordance with the control signal Gctrl. The switch 513 opens and closes a path between the other end of the capacitor 518 and the other end of the capacitor 519, in accordance with the control signal Gctrl. The switch 514 opens and closes a path between the other end of the capacitor 519 and the other end of the capacitor 520, in accordance with the control signal Gctrl. The switch 515 opens and closes a path between the other end of the capacitor 520 and the other end of the capacitor 521, in accordance with the control signal Gctrl.

The timing control circuit 212 controls only one of the switches 511 to 515 to be in an open state and the others to be in a closed state, in accordance with the control signal Gctrl. This control changes the capacitance ratio between the combined capacitance of the capacitances inserted between the signal line 309 and the node 522 on the vertical signal line side, and the combined capacitance of the capacitances inserted between the DAC 213 and the node 522 on the ramp signal side. Hereinafter, the combined capacitance on the vertical signal line side will be referred to as the “VSL-side capacitance”, and the combined capacitance on the ramp signal side will be referred to as the “ramp-side capacitance”. In the drawing, the timing control circuit 212 can switch the capacitance ratio in five stages by controlling the five switches.

Note that, although the capacitance ratio is switched in five stages, the timing control circuit 212 can switch the capacitance ratio in a plurality of stages other than five stages. Where the number of stages is M (M being an integer), M switches and M+1 capacitors are disposed in the capacitance ratio switching circuit 510.

Furthermore, the capacitance value of the capacitor 516 is the greatest, and the respective capacitance values of the capacitors 517 to 521 are set to be the same. Note that the capacitance value of each of the capacitors 516 to 521 can be set to a desired value.

A capacitor 540 holds a predetermined reference voltage VSH.

The differential amplifier circuit 530 amplifies a difference between the voltage of the node 522 and the reference voltage VSH. The differential amplifier circuit 530 includes p-channel MOS (pMOS) transistors 531 and 532, auto-zero switches 536 and 537, and nMOS transistors 533 to 535.

The pMOS transistors 531 and 532 are connected in parallel to the power supply. The gate of the pMOS transistor 531 is connected to its own drain and the gate of the pMOS transistor 532.

The drain of the nMOS transistor 533 is connected to the pMOS transistor 531, and the source thereof is connected to a common node. Furthermore, the gate of the nMOS transistor 533 is connected to the node 522. The drain of the nMOS transistor 534 is connected to the pMOS transistor 532, and the source thereof is connected to the common node. Furthermore, the gate of the nMOS transistor 534 is connected to the capacitor 540.

The nMOS transistor 535 is inserted between the common node and a ground terminal, and a predetermined bias voltage Vbias is input to the gate.

The auto-zero switch 536 short-circuits between the drain and the gate of the nMOS transistor 533, in accordance with an auto-zero signal Az from the timing control circuit 212. The auto-zero switch 537 short-circuits between the drain and the gate of the nMOS transistor 534, in accordance with the auto-zero signal Az.

Furthermore, the comparison result CMP is output from the connection node between the pMOS transistor 532 and the nMOS transistor 534 to the counter 271.

A signal whose level increases with the lapse of time is input as the ramp signal Rmp to the comparator 500 having the configuration illustrated as an example in the drawing, within the AD conversion period.

Note that the ADCs 270 switch analog gains by changing the capacitance ratio, but are not limited to this configuration. The capacitance ratio switching circuit 510 may not be provided, and the timing control circuit 212 may control the DAC 213 to change the velocity at which the level of the ramp signal fluctuates (in other words, the inclination of the slope). In this case, the higher the fluctuation velocity of the ramp signal, the lower the analog gain. Also, the lower the fluctuation velocity, the higher the analog gain.

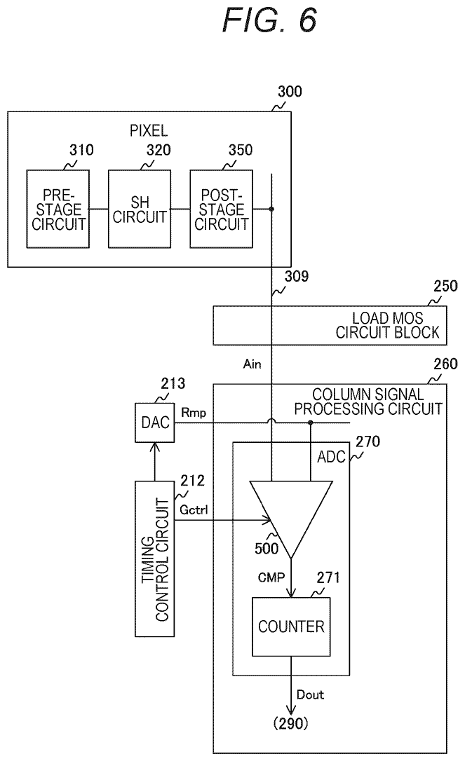

FIG. 6 is a diagram for explaining an operation of the solid-state imaging element 200 at a time of imaging according to the first embodiment of the present technology. Note that, in the drawing, the post-stage reset transistor 341 in the pixel 300 is not shown.

The pre-stage circuit 310 in the pixel 300 generates an analog pixel signal. The sample-and-hold circuit 320 samples the pixel signal (the reset level and the signal level), and holds the pixel signal over the holding period. The sample-and-hold circuit 320 then outputs the pixel signal Ain a plurality of times via the post-stage circuit 350.

The comparator 500 compares the pixel signal Ain with the ramp signal Rmp, and supplies the comparison result CMP to the counter 271. Furthermore, the comparator 500 amplifies the pixel signal Ain with an analog gain designated by the control signal Gctrl among a plurality of gains. The timing control circuit 212 sequentially designates the plurality of gains with the control signal Gctrl within the holding period.

The number of outputs of a pixel signal within the holding period and the number of gains are set to be the same. For example, in a case where M (M being an integer of 2 or greater) gains are sequentially designated, the sample-and-hold circuit 320 outputs a pixel signal (the reset level and the signal level) M times within the holding period. The reset level and the signal level are alternately output, and a total of M reset levels and M signal levels are output.

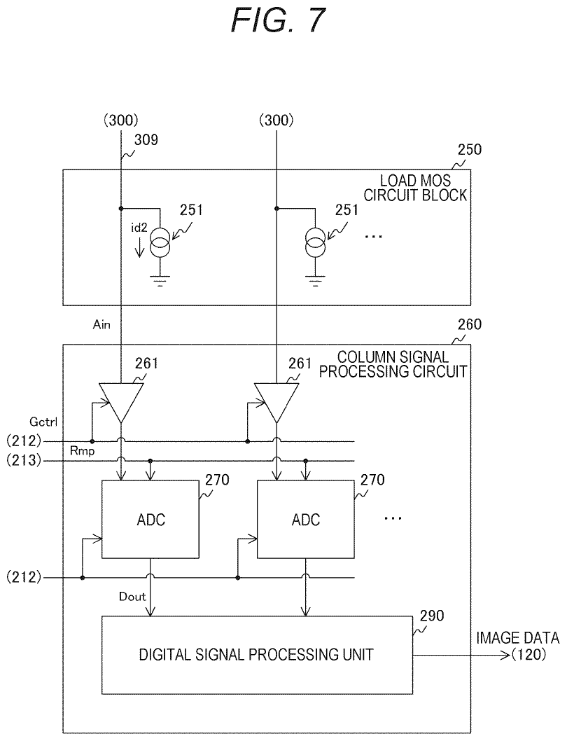

Note that the timing control circuit 212 controls the analog gain of the ADC 270, but is not limited to this configuration. As illustrated in an example in FIG. 7, for each column, a column amplifier 261 may be added to the preceding stage of the ADC 270, and the timing control circuit 212 may control the analog gain of the column amplifier 261. Note that the column amplifier 261 is an example of the amplifier circuit disclosed in the claims.

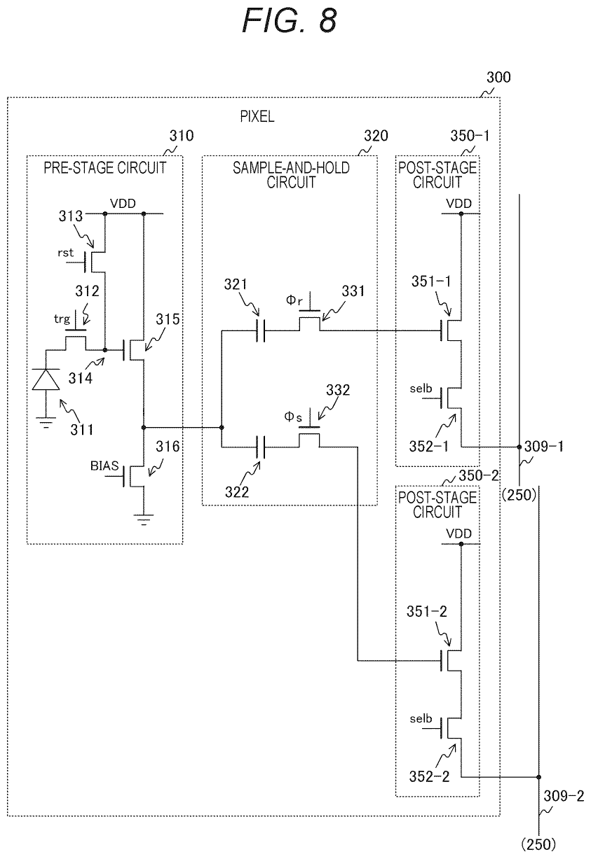

Furthermore, the configuration of each pixel 300 is not limited to the circuit illustrated as an example in FIG. 3. For example, as illustrated in an example in FIG. 8, the number of post-stage circuits may be two. In this case, the selection transistor 331 is only required to open and close a path between the capacitor element 321 and a post-stage circuit 350-1, and the selection transistor 332 is only required to open and close a path between the capacitor element 322 and a post-stage circuit 350-2. The post-stage circuit 350-1 includes a post-stage amplification transistor 351-1 and a post-stage selection transistor 352-1, and the post-stage circuit 350-2 includes a post-stage amplification transistor 351-2 and a post-stage selection transistor 352-2. Furthermore, two vertical signal lines are wired for each column, the post-stage circuit 350-1 outputs a pixel signal to a vertical signal line 309-1, and the post-stage circuit 350-2 outputs a pixel signal to a vertical signal line 309-2.

### [Example Operation of the Solid-State Imaging Element]

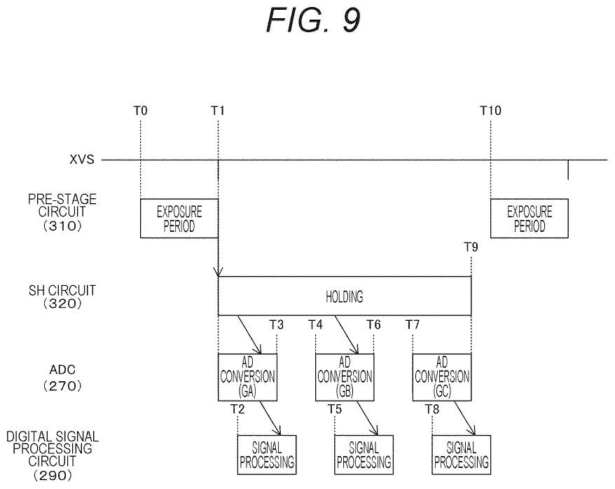

FIG. 9 is a timing chart illustrating an example of an operation of the solid-state imaging element 200 according to the first embodiment of the present technology. This operation is started when the gain switching mode is set. It is assumed that three different analog gains are used in the gain switching mode. The first gain is represented by GA, the second gain is represented by GB, and the third gain is represented by GC. Note that the number of gains to be used in the gain switching mode is not limited to three, as long as it is equal to or smaller than the number of stages of gains that can be switched by the ADCs 270. For example, in a case where the ADCs 270 can switch gains in five stages, two to five gains can be used in the gain switching mode.

Within the exposure period from timing T0 to timing T1 immediately before the vertical synchronization signal XVS falls, all the pixels are exposed by the global shutter method. The pre-stage circuit 310 of each pixel generates a pixel signal. The sample-and-hold circuit 320 samples the pixel signal at the end of the exposure, and holds the pixel signal over the holding period from timing T1 to timing T9.

Within the period from timing T1 to timing T3, the respective sample-and-hold circuits 320 sequentially output the held pixel signals row by row. The ADCs 270 sequentially perform AD conversion on the pixel signals (the reset level and the signal level) row by row. Furthermore, the ADCs 270 amplify the pixel signals with the analog gain GA.

Within a certain period from timing T2, the digital signal processing unit 290 performs signal processing such as a CDS process on each of the pixel signals after the AD conversion. As a result, the first piece of image data is generated.

Further, within the period from timing T4 to timing T6, the respective sample-and-hold circuits 320 sequentially output the held pixel signals row by row. The ADCs 270 amplify the pixel signals with the analog gain GB, and sequentially perform AD conversion on the pixel signals row by row. Within a certain period from timing T5, the digital signal processing unit 290 performs signal processing. As a result, the second piece of image data is generated.

Subsequently, within the period from timing T7 to timing T9, the respective sample-and-hold circuits 320 sequentially output the held pixel signals row by row. The ADCs 270 amplify the pixel signals with the analog gain GC, and sequentially perform AD conversion on the pixel signals row by row. Within a certain period from timing T8, the digital signal processing unit 290 performs signal processing. As a result, the third piece of image data is generated.

Within the exposure period from timing T10 immediately before the vertical synchronization signal XVS falls next time, all the pixels are exposed by the global shutter method. Thereafter, control similar to the control performed from timing T1 to timing T9 is performed.

As described above, three gains are sequentially used, so that three pieces of image data that vary in brightness can be generated by one exposure operation. The imaging device 100 displays the three pieces of image data, and the user selects image data with appropriate brightness among them. For example, the imaging device 100 records the selected image data, and deletes the other data. Thus, the imaging device 100 can record image data that has been captured at an appropriate imaging timing, and has the brightness desired by the user.

Note that, in a case where the normal mode is set, the pixel signal is held from timing T1 to timing T3, and only the first AD conversion from timing T1 to timing T3 is performed. As a result, one piece of image data having a predetermined brightness is generated by one exposure operation.

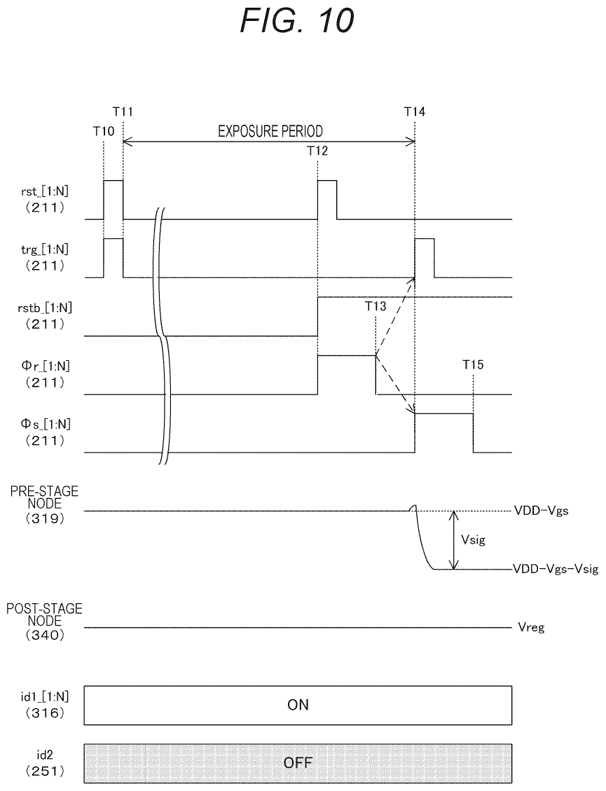

FIG. 10 is a timing chart illustrating an example of a global shutter operation according to the first embodiment of the present technology. The drawing illustrates details of the period from timing T0 to timing T1 in FIG. 9.

In FIG. 10, the vertical scanning circuit 211 supplies the high-level FD reset signal rst and the high-level transfer signal trg to all the rows (in other words, all the pixels) over a period from timing T10 immediately before the start of exposure to timing T11 after the end of the pulse period. As a result, all the pixels are PD reset, and exposure starts simultaneously in all the rows.

Here, rst_[n] and trg_[n] in the drawing represent signals to the pixels in the n-th row among N rows. N is an integer indicating the total number of rows, and n is an integer from 1 to N.

Further, at timing T12 immediately before the end of the exposure period, the vertical scanning circuit 211 supplies the high-level FD reset signal rst over the pulse period, while setting the post-stage reset signal rstb and the selection signal or to the high level for all the pixels. As a result, all the pixels are FD reset, and the reset level is sampled and held. Here, rstb_[n] and Φr_[n] in the drawing represent signals to the pixels in the n-th row.

At timing T13 after timing T12, the vertical scanning circuit 211 returns the selection signal Ør to the low level.

At timing T14 that is the end of the exposure, the vertical scanning circuit 211 supplies the high-level transfer signal trg over the pulse period, while setting the post-stage reset signal rstb and the selection signal @s to the high level for all the pixels. As a result, the signal level is sampled and held. Furthermore, the level of the pre-stage node 319 drops from the reset level (VDD-Vgs) to the signal level (VDD-Vgs-Vsig). Here, VDD represents the power supply voltage, and Vsig represents the net signal level obtained by the CDS process. Vgs represents the gate-source voltage of the pre-stage amplification transistor 315. Furthermore, Φs_[n] in the drawing represents signals to the pixels in the n-th row.

At timing T15 after timing T14, the vertical scanning circuit 211 returns the selection signal Φs to the low level.

Furthermore, the vertical scanning circuit 211 controls the current source transistors 316 of all the rows (all the pixels) to supply the current id1. Here, id1 [n] in the drawing represents the current of pixels in the n-th row. The larger the current id, the larger the IR drop. Therefore, the current id1 needs to be on the order of several nanoamperes (nA) to several tens of nanoamperes (nA). Meanwhile, the load MOS transistors 251 of all the columns are in an off-state, and the current id2 is not supplied to the vertical signal lines 309.

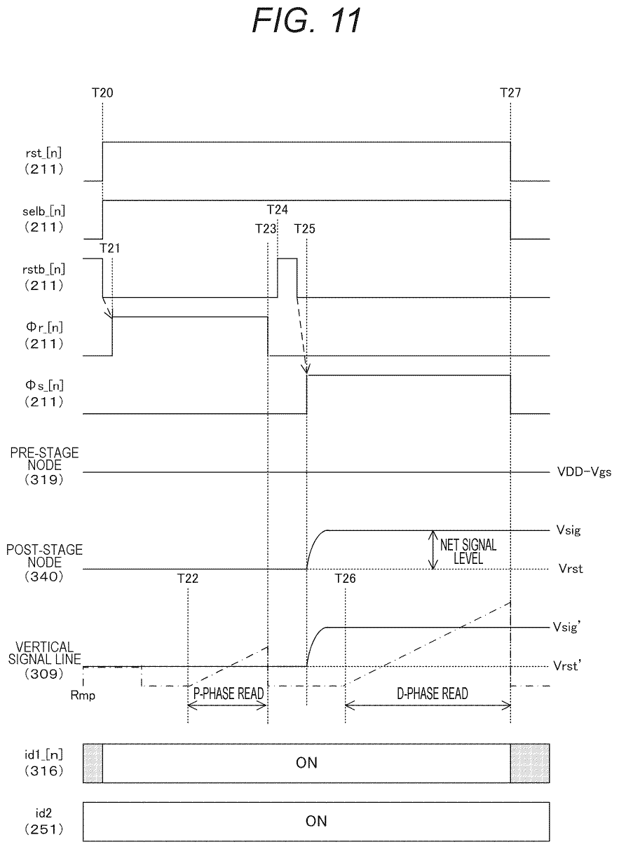

FIG. 11 is a timing chart illustrating an example of a read operation according to the first embodiment of the present technology. The drawing illustrates details of the read period for one row in the period from timing T1 to timing T3 in FIG. 9.

In the read period for the n-th row from timing T20 to timing T27 in FIG. 11, the vertical scanning circuit 211 sets the FD reset signal rst and the post-stage selection signal selb of the n-th row to the high level. Furthermore, in the read period, the post-stage reset signal rstb of all the rows is controlled to the low level. Here, selb [n] in the drawing represents signals to the pixels in the n-th row.

The vertical scanning circuit 211 supplies the high-level selection signal or to the n-th row over the period from timing T21 immediately after timing T20 to timing T23. The potential of the post-stage node 340 becomes the reset level Vrst.

The DAC 213 gradually increases the ramp signal Rmp over the period from timing T22 after timing T21 to timing T23. The ADCs 270 compare the ramp signal Rmp with the level Vrst′ of the vertical signal lines 309, and counts the count value over the period until the comparison result is inverted. Thus, the P-phase level (reset level) is read.

The vertical scanning circuit 211 supplies the high-level post-stage reset signal rstb to the n-th row over the pulse period from timing T24 immediately after timing T23. As a result, in a case where a parasitic capacitance is present in the post-stage node 340, the history of the previous signal held in the parasitic capacitance can be erased.

The vertical scanning circuit 211 supplies the high-level selection signal Φs to the n-th row over the period from timing T25 immediately after the initialization of the post-stage node 340 to timing T27. The potential of the post-stage node 340 becomes the signal level Vsig. During the exposure, the signal level is lower than the reset level. During the reading, however, the signal level is higher than the reset level, because the post-stage node 340 is used as the reference. The difference between the reset level Vrst and the signal level Vsig corresponds to the net signal level from which reset noise and offset noise of the FD have been removed.

The DAC 213 gradually increases the ramp signal Rmp over the period from timing T26 after timing T25 to timing T27. The ADCs 270 compare the ramp signal Rmp with the level Vrst′ of the vertical signal lines 309, and counts the count value over the period until the comparison result is inverted. As a result, the D-phase level (signal level) is read.

Also, the vertical scanning circuit 211 controls the current source transistors 316 of the n-th row to be read, over the period from timing T20 to timing T27, to supply the current id1. Furthermore, the timing control circuit 212 controls the load MOS transistors 251 of all the columns during the read periods of all the rows, to supply the current id2.

Note that the solid-state imaging element 200 reads the signal level after the reset level, but is not limited to this order. The solid-state imaging element 200 can also read the reset level after the signal level. In this case, the vertical scanning circuit 211 supplies the high-level selection signal or after the high-level selection signal Φs. Also, it is necessary to reverse the inclination of the slope of the ramp signal.

Here, a configuration in which the sample-and-hold circuit 320 is not provided for each pixel is assumed as a comparative example.

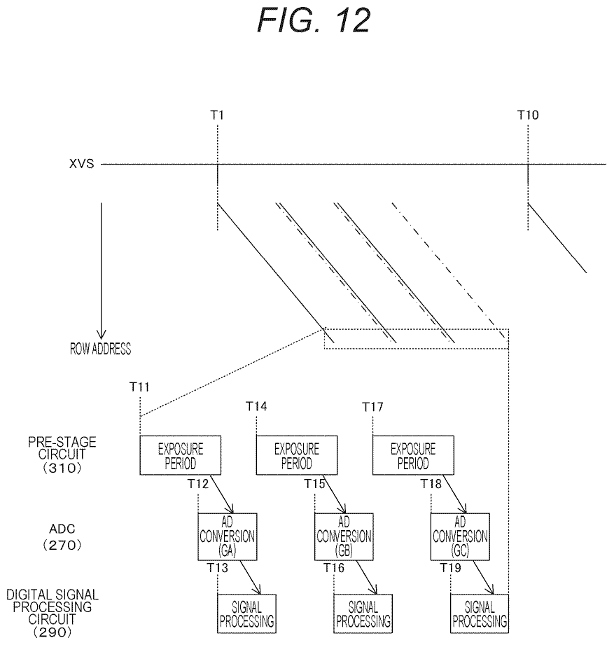

FIG. 12 is a timing chart illustrating an example of an operation of a solid-state imaging element in the comparative example. In the comparative example, when the gain switching mode is set, exposure is performed three times by the rolling shutter method after timing T1. In the drawing, the solid lines drawn diagonally indicate the exposure start timings, and the dot-and-dash lines indicates the exposure end timings.

When a certain row is taken as an example, the row is exposed over an exposure period from timing T11. After timing T12, the ADCs 270 amplify the pixel signals of the current row with the analog gain GA, and performs AD conversion on the pixel signals of the row. After timing T13, the digital signal processing unit 290 performs signal processing on each of the pixel signals after the AD conversion. As a result, the first piece of image data is generated.

The current row is exposed over an exposure period from timing T14. After timing T15, the ADCs 270 amplify the pixel signals of the current row with the analog gain GB, and performs AD conversion on the pixel signals of the row. After timing T16, the digital signal processing unit 290 performs signal processing on each of the pixel signals after the AD conversion. As a result, the second piece of image data is generated.

The current row is then exposed over an exposure period from timing T17. After timing T18, the ADCs 270 amplify the pixel signals of the current row with the analog gain GC, and performs AD conversion on the pixel signals of the row. After timing T19, the digital signal processing unit 290 performs signal processing on each of the pixel signals after the AD conversion. As a result, the third piece of image data is generated.

As described above, in the comparative example, exposure is performed in units of row by the rolling shutter method. Furthermore, three pieces of image data can be generated also in the comparative example by switching analog gains. However, the exposure start timings corresponding to the three respective pieces of image data are different. Therefore, there is a possibility that, when the subject moves, the position and the shape of the subject in the image data will change. As a result, image data with desired brightness is not captured at an appropriate imaging timing in some cases.

For example, a case where the first piece of image data is captured at an appropriate imaging timing, and the brightness of the second piece of image data is the brightness desired by the user is now discussed. In this case, the first piece of image data does not have the brightness desired by the user, and the second and third pieces of image data might differ from the first piece of image data in the position and the shape of the subject. In this manner, in the comparative example, there is a possibility that an opportunity to capture image data having the desired brightness at an appropriate imaging timing will be missed.

On the other hand, if the sample-and-hold circuits 320 are provided for the respective pixels, and the control illustrated in FIG. 6 in which gains are switched within the holding period is performed, image data of a plurality of levels of brightness can be generated by one exposure operation. Thus, it is possible to prevent loss of imaging opportunities, unlike the comparative example.

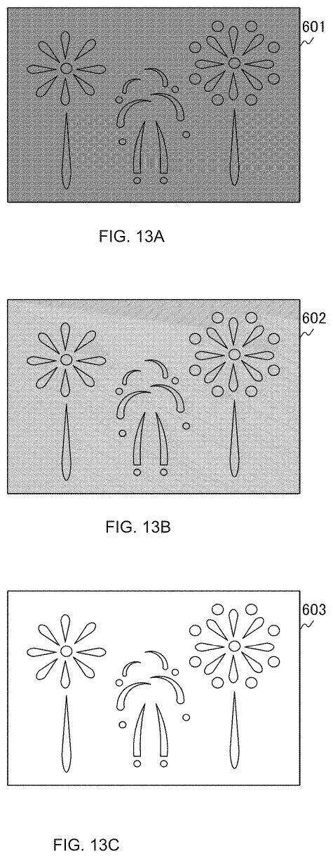

FIG. 13 is a diagram illustrating an example of image data according to the first embodiment of the present technology. In the drawing, a indicates image data 601 generated with the analog gain GA, and b in the drawing indicates image data 602 generated with the analog gain GB. In the drawing, c indicates image data 603 generated with the analog gain GC.

The analog gain GB is greater than the analog gain GA, and is smaller than the analog gain GC. In this case, the image data 602 is brighter than the image data 601, and is darker than the image data 603.

Furthermore, gains are switched within a holding period of the sample-and-hold circuit 320 as described above. Accordingly, the timings of the exposure start and the exposure end for the three pieces of image data are the same. As a result, even if the subject is a moving subject such as a firework, the position and the shape of the subject in the image data do not change.

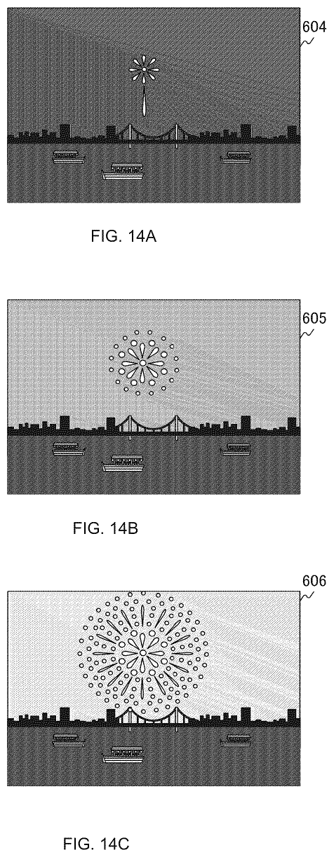

FIG. 14 is a diagram illustrating an example of image data according to the comparative example. In the drawing, a indicates image data 604 generated with the analog gain GA, and b in the drawing indicates image data 605 generated with the analog gain GB. In the drawing, c indicates image data 606 generated with the analog gain GC.

As illustrated as an example in the figure, the brightnesses of the three pieces of image data vary depending on the differences among the analog gains. In the comparative example, however, the exposure start timings of the three pieces of image data are different from one another. Therefore, in the case of a moving subject such as a firework, the position and the shape of the subject change in each of the three images. As a result, there is a possibility that an opportunity to capture image data having the desired brightness at an appropriate imaging timing will be missed.

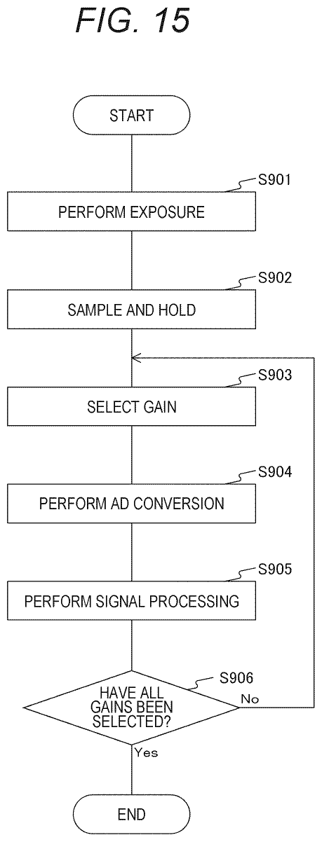

FIG. 15 is a flowchart illustrating an example of an operation of the imaging device 100 according to the first embodiment of the present technology. This operation is started when the gain switching mode is set, for example.

The imaging device 100 performs exposure by the global shutter method (step S901). The sample-and-hold circuit 320 of each pixel then samples and holds a pixel signal (step S902). The timing control circuit 212 in the imaging device 100 selects one gain of a plurality of gains within the holding period, and notifies the ADCs 270 of the selected gain (step S903). The ADCs 270 amplify the pixel signals with the instructed gain, and performs AD conversion (step S904). The digital signal processing unit 290 in the imaging device 100 performs signal processing on each of the pixel signals after the AD conversion (step S905).

The timing control circuit 212 determines whether or not all the gains to be used in the gain switching mode have been selected (step S906). If not all the gains have been selected (step S906: No), the imaging device 100 repeats step S903 and the subsequent steps. If all the gains have been selected (step S906: Yes), on the other hand, the imaging device 100 displays a screen for allowing the user to select any piece of a plurality of pieces of image data having different brightnesses, and then ends the operation for imaging.

Note that, in a case where exposure is successively performed a plurality of times, steps S901 to S906 are repeatedly carried out in synchronization with the vertical synchronization signal XVS.

As described above, according to the first embodiment of the present technology, the timing control circuit 212 sequentially designates a plurality of gains within the holding period of the sample-and-hold circuit 320, so that the solid-state imaging element 200 can generate a plurality of pieces of image data having different brightnesses by one exposure operation. Thus, loss of an imaging opportunity can be prevented.

### [First Modification]

In the first embodiment described above, the image data of the brightness selected by the user is recorded. In this configuration, however, it is necessary for the user to select a brightness each time imaging is performed. A solid-state imaging element 200 according to a first modification of the first embodiment differs from that of the first embodiment in that the gain value corresponding to the brightness selected by the user is held.

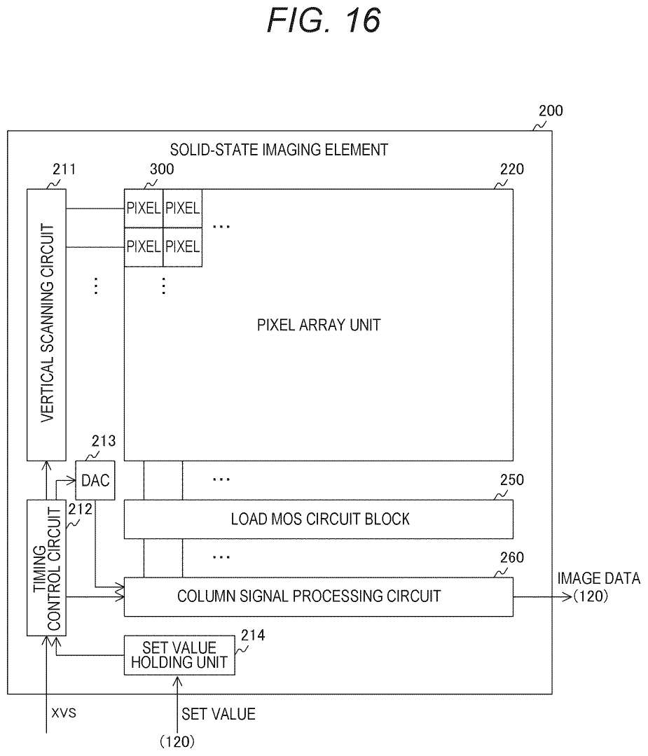

FIG. 16 is a block diagram illustrating an example configuration of the solid-state imaging element 200 according to the first modification of the first embodiment of the present technology. The solid-state imaging element 200 according to the first modification of the first embodiment differs from that of the first embodiment in further including a set value holding unit 214. As the set value holding unit 214, a register or the like is used. Note that the set value holding unit 214 may also be disposed outside the solid-state imaging element 200.

When a brightness is selected by the user in the gain switching mode, the DSP circuit 120 causes the set value holding unit 214 to hold the value of the gain corresponding to the brightness as a set value. When the normal mode is set, the solid-state imaging element 200 then amplifies pixel signals with the gain of the set value held in the set value holding unit 214. The set value in the set value holding unit 214 is initialized when the gain switching mode is set or when the power supply to the imaging device 100 is turned off.

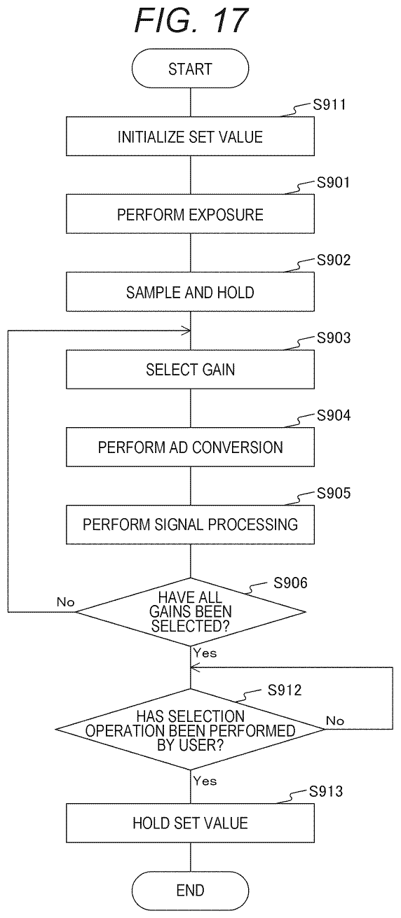

FIG. 17 is a flowchart illustrating an example of an operation of the imaging device 100 according to the first embodiment of the present technology. When the gain switching mode is set, the DSP circuit 120 initializes the set value in the set value holding unit 214 (step S911). The solid-state imaging element 200 then carries out steps S901 to S906.

If all the gains have been selected (step S906: Yes), the imaging device 100 displays a screen for allowing the user to select any piece of a plurality of pieces of image data having different brightnesses, and determines whether or not the user has performed a selection operation (step S912).

If any selection operation has not been performed (step S912: No), the imaging device 100 repeats step S912. If a selection operation has been performed (step S912: Yes), on the other hand, the imaging device 100 holds the value of the gain corresponding to the brightness selected by the user as the set value in the set value holding unit 214 (step S913), and shifts to the normal mode to end the operation. During imaging in the subsequent normal mode, pixel signals are amplified with the gain of the set value in the set value holding unit 214. Further, the set value holding unit 214 is initialized when the power supply is turned off.

As described above, the set value holding unit 214 holds the value of a gain among a plurality of gains in accordance with an operation by the user, so that the user does not need to select a brightness every time imaging is performed in the normal mode, and the user-friendliness of the imaging device 100 is enhanced accordingly.

As described above, according to the first modification of the first embodiment of the present technology, the set value holding unit 214 holds the value of a gain among a plurality of gains in accordance with an operation by the user, the user-friendliness of the imaging device 100 can be enhanced.

### [Second Modification]

In the first embodiment described above, the imaging device 100 displays a plurality of pieces of image data having different brightnesses to allow the user to select a desired brightness. However, these pieces of image data can also be used for machine learning. An imaging device 100 according to a second modification of the first embodiment differs from that of the first embodiment in that machine learning is performed using a plurality of pieces of image data having different brightnesses.

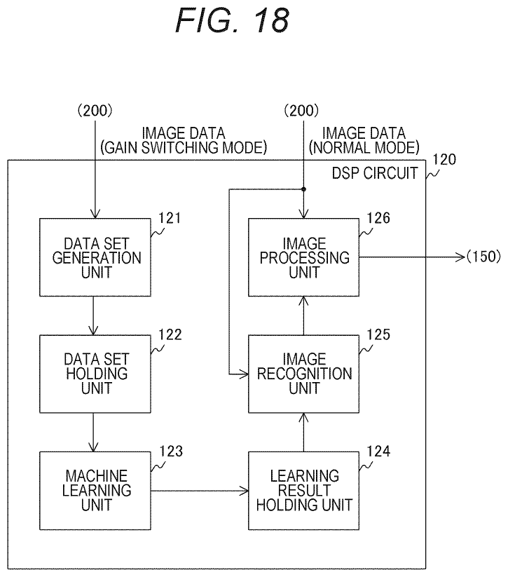

FIG. 18 is a block diagram illustrating an example configuration of a DSP circuit 120 according to the second modification of the first embodiment of the present technology. The DSP circuit 120 according to the second modification of the first embodiment includes a data set generation unit 121, a data set holding unit 122, a machine learning unit 123, a learning result holding unit 124, an image recognition unit 125, and an image processing unit 126.

A plurality of pieces of image data captured in the gain switching mode is input to the data set generation unit 121. The data set generation unit 121 generates, from these pieces of image data, a data set to be used in machine learning. For example, in a case where M pieces of image data having different brightnesses are generated, the data set generation unit 121 sets one of the M pieces as a reference image, generates a difference image between each of the remaining pieces of image data and the reference image, and sets these difference images as a data set. The data set generation unit 121 causes the data set holding unit 122 to hold the data set including the M−1 difference images.

The machine learning unit 123 performs machine learning for recognizing the subject in the reference image, using the data set. The machine learning unit 123 causes the learning result holding unit 124 to hold a learning result.

Image data captured in the normal mode is input to the image recognition unit 125. The image recognition unit 125 performs image recognition on the image data on the basis of the learning result, and supplies a recognition result to the image processing unit 126.

The image data captured in the normal mode is input to the image processing unit 126. The image processing unit 126 performs various kinds of image processing on the image data on the basis of the recognition result. The processed image data is supplied to the storage unit 170 and the display unit 130 via the bus 150.

In the normal mode and a comparative example, M times of exposure are required to generate M pieces of image data having different brightnesses. In the gain switching mode, however, those pieces of image data can be generated by one exposure operation. Thus, it is possible to reduce the number of exposure operations necessary for generating a data set.

As described above, according to the second modification of the first embodiment of the present technology, the imaging device 100 performs machine learning using a plurality of pieces of image data in the gain switching mode, and thus, the number of exposure operations necessary for generating a data set can be reduced.

### 2. Second Embodiment

In the first embodiment described above, analog gains of the ADCs 270 are switched by changing the capacitance ratio and the fluctuation velocity of the ramp signal. However, in a case where the capacitance ratio is changed, the circuit size of the ADCs 270 is larger. Furthermore, in a case where the fluctuation velocity of the ramp signal is changed, the AD conversion time becomes longer as the fluctuation velocity is lowered. A solid-state imaging element 200 according to a second embodiment differs from that of the first embodiment in that analog gains of an amplifier circuit in each pixel are switched.

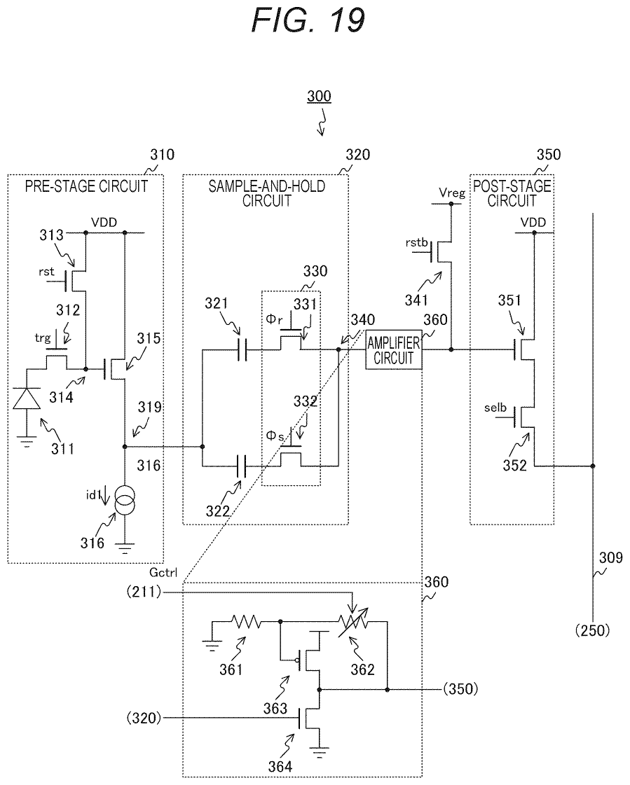

FIG. 19 is a circuit diagram illustrating an example configuration of a pixel 300 according to the second embodiment of the present technology. This pixel 300 of the second embodiment differs from that of the first embodiment in further including an amplifier circuit 360.

The amplifier circuit 360 amplifies a pixel signal (the signal level and the reset level) from the sample-and-hold circuit 320 with the analog gain designated by the control signal Gctrl, and supplies the amplified pixel signal to the post-stage circuit 350. The amplifier circuit 360 includes a resistor 361, a variable resistor 362, a pMOS transistor 363, and an nMOS transistor 364.

The pMOS transistor 363 and the nMOS transistor 364 are connected in series between the power supply voltage and the ground voltage, with the pMOS transistor 363 being on the power supply side. The gate of the nMOS transistor 364 is connected to the sample-and-hold circuit 320. The connection node between the pMOS transistor 363 and the nMOS transistor 364 is connected to the post-stage circuit 350.

The resistor 361 is inserted between the gate of the pMOS transistor 363 and the ground potential. The variable resistor 362 is inserted between the gate of the pMOS transistor 363 and the connection node between the pMOS transistor 363 and the nMOS transistor 364. Furthermore, the resistance value of the variable resistor 362 is controlled by the control signal Gctrl.

As illustrated in the example in the drawing, in the second embodiment, analog gains of the amplifier circuit 360 in each pixel are switched, which eliminates the need to change the capacitance ratio of the ADCs 270 and the fluctuation velocity of the ramp signal.

Note that the first modification and second modification of the first embodiment can be applied to the second embodiment.

As described above, according to the second embodiment of the present technology, analog gains of the amplifier circuit 360 in each pixel are switched, and thus, the circuit size of the ADCs 270 can be made smaller compared with that in a case where the capacitance ratio is changed. Furthermore, the AD conversion time can be made shorter compared with that in a case where the fluctuation velocity of the ramp signal is changed.

### 3. Third Embodiment

In the first embodiment described above, analog gains of the ADCs 270 are switched by changing the capacitance ratio and the fluctuation velocity of the ramp signal. However, in a case where the capacitance ratio is changed, the circuit size of the ADCs 270 is larger. Furthermore, in a case where the fluctuation velocity of the ramp signal is changed, the AD conversion time becomes longer as the fluctuation velocity is lowered. A solid-state imaging element 200 according to a third embodiment differs from that of the first embodiment in that digital gains for a pixel signal after AD conversion are switched.

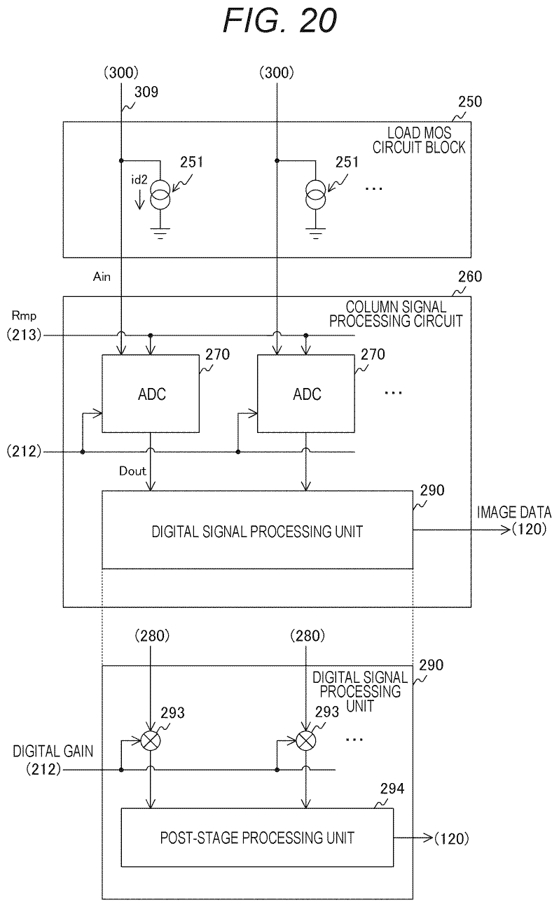

FIG. 20 is a block diagram illustrating an example configuration of the column signal processing circuit 260 according to the third embodiment of the present technology. In the third embodiment, the timing control circuit 212 does not switch analog gains of the ADCs 270. Therefore, the capacitance ratio of the comparators of the ADCs 270 is fixed, and the capacitors and switches for switching capacitance ratios are unnecessary.

Furthermore, the digital signal processing unit 290 of the third embodiment includes a plurality of multipliers 293 and a post-stage processing unit 294. The multipliers 293 are provided for the respective columns.

The multipliers 293 each multiply an AD-converted pixel signal (the reset level and the signal level) by a digital gain from the timing control circuit 212, and supplies a multiplication result to the post-stage processing unit 294. As a result, each of the reset level and the signal level is amplified with the digital gain.

Note that the multipliers 293 each amplify the reset level and the signal level with a digital gain before the CDS process, but can also amplify the net signal level with a digital gain after the CDS process. In this case, the ADCs 270 performs the CDS process in addition to the AD conversion, for example. Alternatively, a circuit that performs the CDS process may be inserted in a subsequent stage of the ADCs 270.

The post-stage processing unit 294 performs various kinds of signal processing on the amplified pixel signals.

As described above, AD-converted pixel signals are amplified with a digital gain, which eliminates the need to change the capacitance ratio of the ADCs 270 and the fluctuation velocity of the ramp signal.

Note that the first modification and second modification of the first embodiment can be applied to the third embodiment.

As described above, according to the third embodiment of the present technology, the multipliers 293 amplify AD-converted pixel signals with a digital gain, and thus, the circuit size of the ADCs 270 can be made smaller compared with that in a case where the capacitance ratio is changed. Furthermore, the AD conversion time can be made shorter compared with that in a case where the fluctuation velocity of the ramp signal is changed.

### 4. Fourth Embodiment

In the first embodiment described above, the pre-stage circuit 310 reads a signal while being connected to the pre-stage node 319. However, this configuration cannot block noise from the pre-stage node 319 during reading. A pixel 300 according to a fourth embodiment differs from that of the first embodiment in that a transistor is inserted between the pre-stage circuit 310 and the pre-stage node 319.

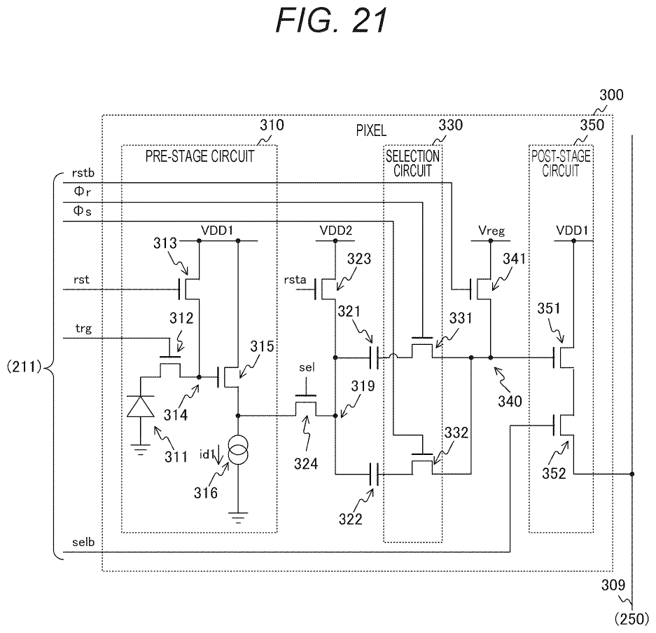

FIG. 21 is a circuit diagram illustrating an example configuration of a pixel 300 according to the fourth embodiment of the present technology. This pixel 300 of the fourth embodiment differs from that of the first embodiment in further including a pre-stage reset transistor 323 and a pre-stage selection transistor 324. Furthermore, the power supply voltage of the pre-stage circuit 310 and the post-stage circuit 350 of the fourth embodiment is represented by VDD1.

The pre-stage reset transistor 323 initializes the level of the pre-stage node 319 with a power supply voltage VDD2. It is desirable that the power supply voltage VDD2 be set to a value satisfying the following expression.

$$VDD 2 = VDD 1 - Vgs \qquad Expession 1$$

In the above expression, Vgs represents the gate-source voltage of the pre-stage amplification transistor 315.

Setting to a value satisfying Expression 1 can reduce variations in potential between the pre-stage node 319 and the post-stage node 340 in the dark. Thus, photo response non-uniformity (PRNU) can be improved.

The pre-stage selection transistor 324 opens and closes a path between the pre-stage circuit 310 and the pre-stage node 319, in accordance with a pre-stage selection signal sel from the vertical scanning circuit 211.

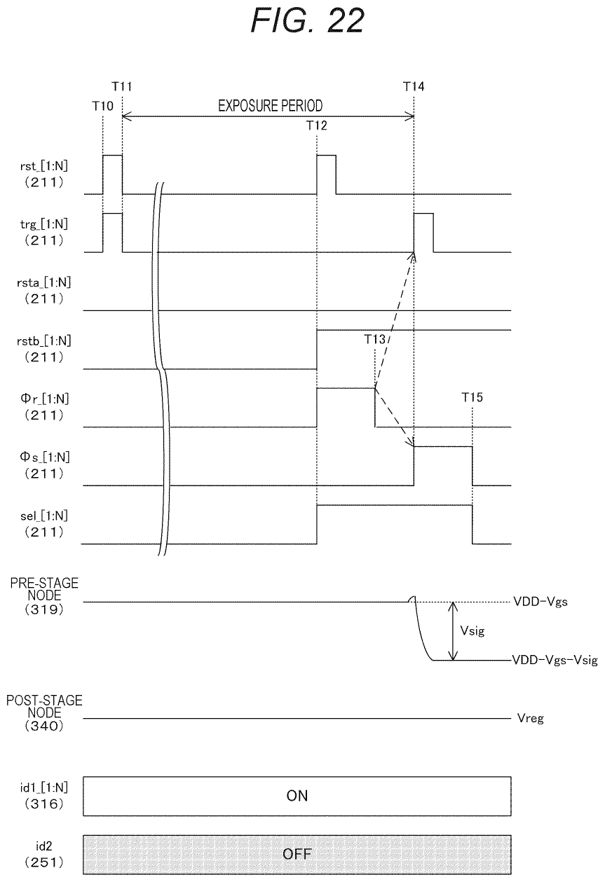

FIG. 22 is a timing chart illustrating an example of a global shutter operation according to the fourth embodiment of the present technology. The timing chart of the fourth embodiment differs from that of the first embodiment in that the vertical scanning circuit 211 further supplies a pre-stage reset signal rsta and the pre-stage selection signal sel. In the drawing, rsta_[n] and sel_[n] represent signals to the pixels in the n-th row.

The vertical scanning circuit 211 supplies a high-level pre-stage selection signal sel to all the pixels over the period from timing T12 immediately before the end of exposure to timing T15. The pre-stage reset signal rsta is controlled to the low level.

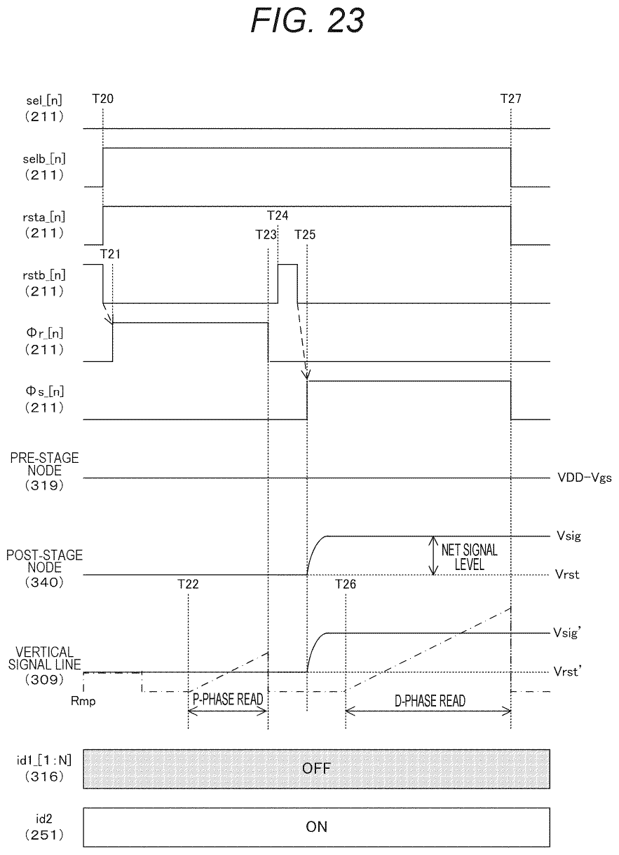

FIG. 23 is a timing chart illustrating an example of a read operation according to the fourth embodiment of the present technology. At the time of reading of each row, the pre-stage selection signal sel is controlled to the low level. This control puts the pre-stage selection transistor 324 into an open state, to disconnect the pre-stage node 319 from the pre-stage circuit 310. Thus, noise from the pre-stage node 319 can be blocked during reading.

Furthermore, over the read period for the n-th row from timing T20 to timing T27, the vertical scanning circuit 211 supplies a high-level pre-stage reset signal rsta to the n-th row.

Furthermore, during reading, the vertical scanning circuit 211 controls the current source transistors 316 of all the pixels to stop the supply of the current id1. The current id2 is supplied in a manner similar to that in the first embodiment. Thus, the control of the current id1 is simplified as compared with the first embodiment.

Note that the first and second modifications of the first embodiment, and the second and third embodiments can be applied to the fourth embodiment.

As described above, according to the fourth embodiment of the present technology, the pre-stage selection transistor 324 shifts to an open state during reading, to disconnect the pre-stage circuit 310 from the pre-stage node 319. Thus, it is possible to block noise from the pre-stage circuit 310.

### [First Modification]

In the fourth embodiment described above, the circuits in the solid-state imaging element 200 are disposed in a single semiconductor chip. With this configuration, however, there is a possibility that the elements might not fit in the semiconductor chip when the pixels 300 are miniaturized. A solid-state imaging element 200 according to a first modification of the fourth embodiment differs from that of the fourth embodiment in that the circuits in the solid-state imaging element 200 are dispersedly disposed in two semiconductor chips.

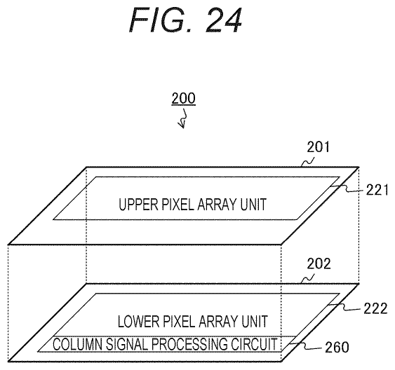

FIG. 24 is a diagram illustrating an example of a stack structure of the solid-state imaging element 200 according to the first modification of the fourth embodiment of the present technology. The solid-state imaging element 200 according to the first modification of the fourth embodiment includes a lower pixel chip 202 and an upper pixel chip 201 stacked on the lower pixel chip 202. These chips are electrically connected by Cu—Cu bonding, for example. Note that, in addition to the Cu—Cu bonding, the connection can be made using a via or a bump.

An upper pixel array unit 221 is disposed in the upper pixel chip 201. A lower pixel array unit 222 and the column signal processing circuit 260 are disposed in the lower pixel chip 202. As for each pixel in the pixel array unit 220, part of the pixel is disposed in the upper pixel array unit 221, and the rest of the pixel is disposed in the lower pixel array unit 222.

Furthermore, in the lower pixel chip 202, the vertical scanning circuit 211, the timing control circuit 212, the DAC 213, and the load MOS circuit block 250 are also disposed. These circuits are not shown in the drawing.

Furthermore, the upper pixel chip 201 is manufactured by a pixel-dedicated process, for example, and the lower pixel chip 202 is manufactured by a CMOS process, for example.

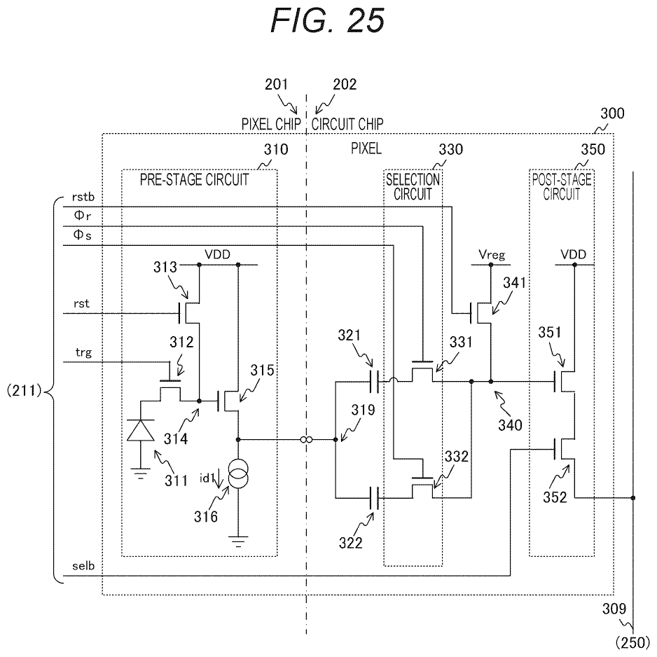

FIG. 25 is a circuit diagram illustrating an example configuration of a pixel 300 according to the first modification of the fourth embodiment of the present technology. In the pixel 300, the pre-stage circuit 310 is disposed in the upper pixel chip 201, and the other circuits and elements (such as the capacitor elements 321 and 322) are disposed in the lower pixel chip 202. Note that the current source transistor 316 can be further disposed in the lower pixel chip 202. As illustrated in the example in the drawing, dispersedly disposed the elements of the pixel 300 in the upper pixel chip 201 and lower pixel chip 202 stacked on top of each other allows a reduction in pixel area, to facilitate pixel miniaturization.

Note that the first, second, and third embodiments can be applied to the first modification of the fourth embodiment.

As described above, according to the first modification of the fourth embodiment of the present technology, the circuits and the elements in the pixels 300 are dispersedly disposed in the two semiconductor chips, to facilitate pixel miniaturization.

### [Second Modification]

In the first modification of the fourth embodiment described above, part of each pixel 300 and the peripheral circuits (such as the column signal processing circuit 260) are disposed in the lower pixel chip 202 on the lower side. In this configuration, however, the installation areas of the circuits and the elements on the side of the lower pixel chip 202 is larger than the installation areas in the upper pixel chip 201 by the amount equivalent to the peripheral circuits, and there is a possibility that an unnecessary space not including any circuits and elements will appear in the upper pixel chip 201. A solid-state imaging element 200 according to a second modification of the fourth embodiment differs from that of the first modification of the fourth embodiment in that the circuits of the solid-state imaging element 200 are dispersedly disposed in three semiconductor chips.

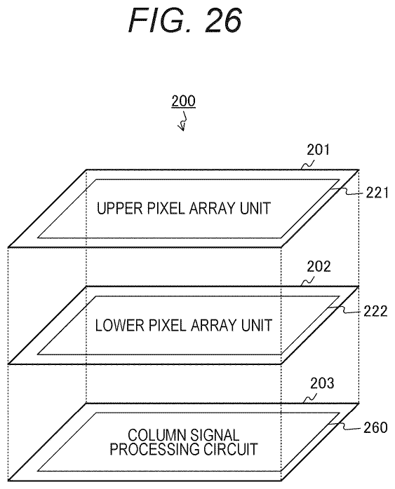

FIG. 26 is a diagram illustrating an example of a stack structure of the solid-state imaging element 200 according to the second modification of the fourth embodiment of the present technology. The solid-state imaging element 200 according to the second modification of the fourth embodiment includes an upper pixel chip 201, a lower pixel chip 202, and a circuit chip 203. These chips are stacked on top of each other, and are electrically connected by Cu—Cu bonding, for example. Note that, in addition to the Cu—Cu bonding, the connection can be made using a via or a bump.

An upper pixel array unit 221 is disposed in the upper pixel chip 201. A lower pixel array unit 222 is disposed in the lower pixel chip 202. As for each pixel in the pixel array unit 220, part of the pixel is disposed in the upper pixel array unit 221, and the rest of the pixel is disposed in the lower pixel array unit 222.

Furthermore, in the circuit chip 203, the column signal processing circuit 260, the vertical scanning circuit 211, the timing control circuit 212, the DAC 213, and the load MOS circuit block 250 are disposed. The circuits other than the column signal processing circuit 260 are not shown in the drawing.

Note that the first, second, and third embodiments can be applied to the second modification of the fourth embodiment.

Adopting the three-layer configuration as illustrated in the example in the drawing allows a reduction in unnecessary space and further pixel miniaturization compared with a two-layer configuration. Furthermore, the lower pixel chip 202 that is the second layer can be manufactured by a dedicated process for capacitors and switches.

As described above, in the second modification of the fourth embodiment of the present technology, the circuits of the solid-state imaging element 200 are dispersedly disposed in the three semiconductor chips. Thus, the pixels can be further miniaturized compared with a case where the circuits are dispersedly disposed in two semiconductor chips.

### 5. Fifth Embodiment

In the first embodiment described above, the reset level is sampled and held during the exposure period. In this configuration, however, the exposure period cannot be made shorter than the sample-and-hold period for the reset level. A solid-state imaging element 200 according to a fifth embodiment differs from that of the first embodiment in that a transistor that discharges electric charge from the photoelectric conversion elements is added to make the exposure period shorter.

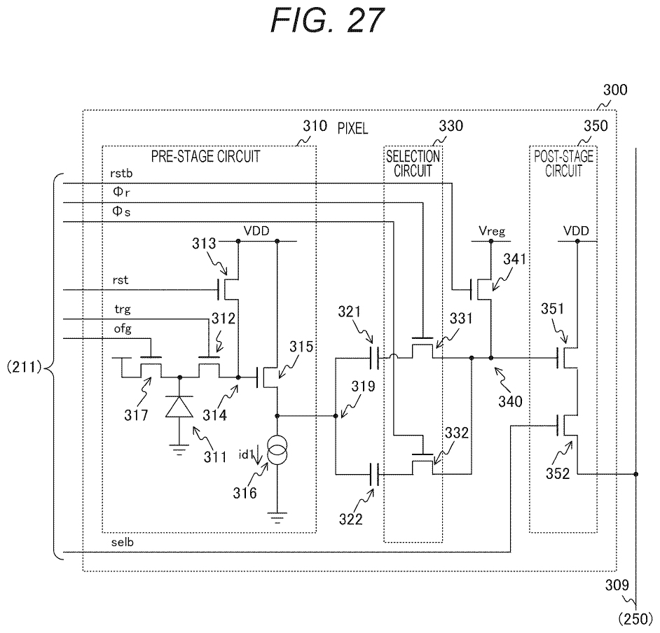

FIG. 27 is a circuit diagram illustrating an example configuration of a pixel 300 according to the fifth embodiment of the present technology. The pixel 300 of the fifth embodiment differs from that of the first embodiment in further including a discharge transistor 317 in the pre-stage circuit 310.

The discharge transistor 317 functions as an overflow drain that discharges electric charge from the photoelectric conversion element 311 in accordance with a discharge signal ofg from the vertical scanning circuit 211. As the discharge transistor 317, an nMOS transistors is used, for example.

In the configuration not including the discharge transistor 317 as in the first embodiment, blooming might occur in any of the pixels, when electric charge is transferred from the photoelectric conversion element 311 to the FD 314. Further, at the time of the FD reset, the potential of the FD 314 and the potential of the pre-stage node 319 drop. In response to the potential drop, charging and discharging currents of the capacitor elements 321 and 322 continue to occur, and the IR drop in the power supply or the ground changes from a steady state without blooming.

On the other hand, at a time of sampling and holding the signal levels of all the pixels, after the transfer of the signal charge, the photoelectric conversion element 311 has no electric charge. Therefore, blooming does not occur, and the IR drop in the power supply or the ground enters a steady state without blooming. Due to a difference in IR drop at the time of sampling and holding the reset level and the signal level, streaking noise appears.

In the fifth embodiment in which the discharge transistor 317 is provided, on the other hand, the electric charge in the photoelectric conversion element 311 is discharged to the overflow drain side. As a result, the IR drops at the time of sampling and holding the reset level and the signal level become almost equal to each other, and thus, streaking noise can be prevented.

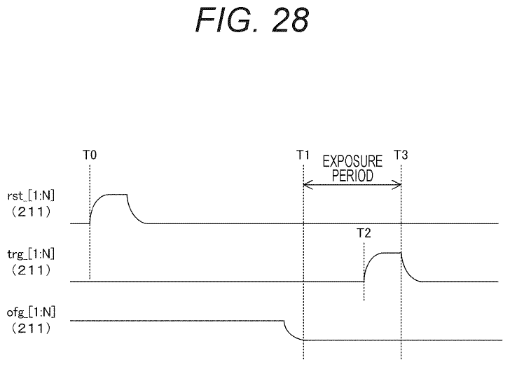

FIG. 28 is a timing chart illustrating an example of a global shutter operation according to the fifth embodiment of the present technology. At timing TO before the timing to start exposure, the vertical scanning circuit 211 supplies a high-level FD reset signal rst to all the pixels over the pulse period, while setting the discharge signal ofg to the high level for all the pixels. As a result, the PD reset and the FD reset are performed on all the pixels. Furthermore, the reset level is sampled and held. Here, ofg [n] in the drawing represents signals to the pixels in the n-th row among the N rows.

Further, at timing T1 to start exposure, the vertical scanning circuit 211 returns the discharge signal ofg to the low level for all the pixels. The vertical scanning circuit 211 then supplies the high-level transfer signal trg to all the pixels over the period from timing T2 immediately before the end of the exposure to timing T3 at the end of the exposure. As a result, the signal level is sampled and held.

In the configuration not including the discharge transistor 317 as in the first embodiment, both the transfer transistor 312 and the FD reset transistor 313 need to be put into an on-state at the start of exposure (which is the time of the PD reset). Under this control, the FD 314 also needs to be reset at the time of the PD reset. Because of this, it is necessary to perform the FD reset again within the exposure period to sample and hold the reset level, and therefore, the exposure period cannot be made shorter than the sample-and-hold period for the reset level. When the reset levels of all the pixels are sampled and held, a certain waiting time is required until the voltage and the current stabilize, and, for example, a sample-and-hold period of several microseconds (μs) to several tens of microseconds (μs) is required.

In the fifth embodiment in which the discharge transistor 317 is provided, on the other hand, the PD reset and the FD reset can be performed separately from each other. Accordingly, as illustrated in the example in the drawing, it is possible to sample and hold the reset level by performing the FD reset before cancellation of the PD reset (the start of exposure). Thus, the exposure period can be made shorter than the sample-and-hold period for the reset level.

Note that the first and second modifications of the first embodiment, and the second to fourth embodiments can be applied to the fifth embodiment.

As described above, according to the fifth embodiment of the present technology, the discharge transistor 317 that discharges electric charge from the photoelectric conversion element 311 is provided, so that it becomes possible to sample and hold the reset level by performing the FD reset before the start of exposure. Thus, the exposure period can be made shorter than the sample-and-hold period for the reset level.

### 6. Sixth Embodiment

In the first embodiment described above, the FD 314 is initialized with the power supply voltage VDD. With this configuration, however, there is a possibility that photo response non-uniformity (PRNU) will deteriorate due to variations of the capacitor elements 321 and 322 or parasitic capacitance. A solid-state imaging element 200 according to a sixth embodiment differs from that of the first embodiment in that PRNU is improved by lowering the power supply to the FD reset transistor 313 at a time of reading.

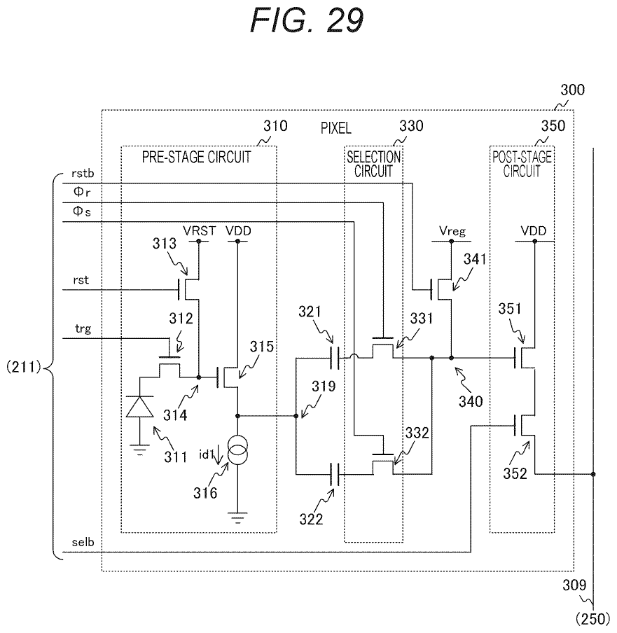

FIG. 29 is a circuit diagram illustrating an example configuration of a pixel 300 according to the sixth embodiment of the present technology. The pixel 300 of the third embodiment differs from that of the first embodiment in that the power supply to the FD reset transistor 313 is separated from the power supply voltage VDD of the pixel 300.

The FD reset transistor 313 of the sixth embodiment has its drain connected to a reset power supply voltage VRST. The reset power supply voltage VRST is controlled by the timing control circuit 212, for example.

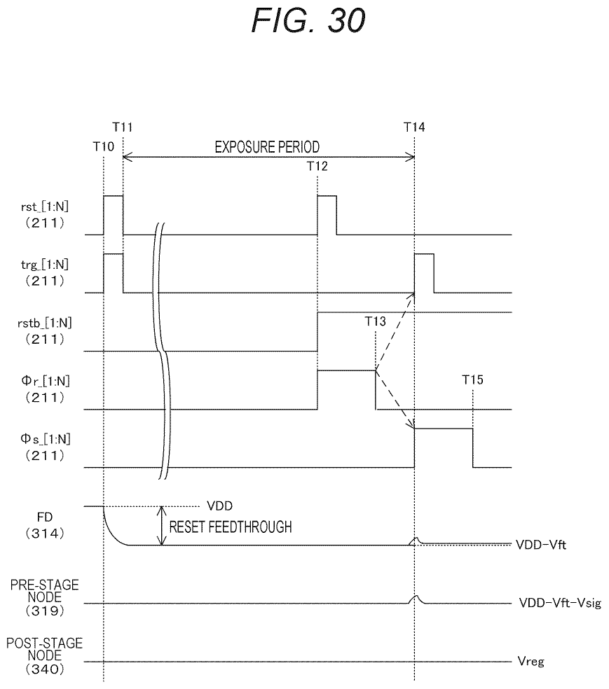

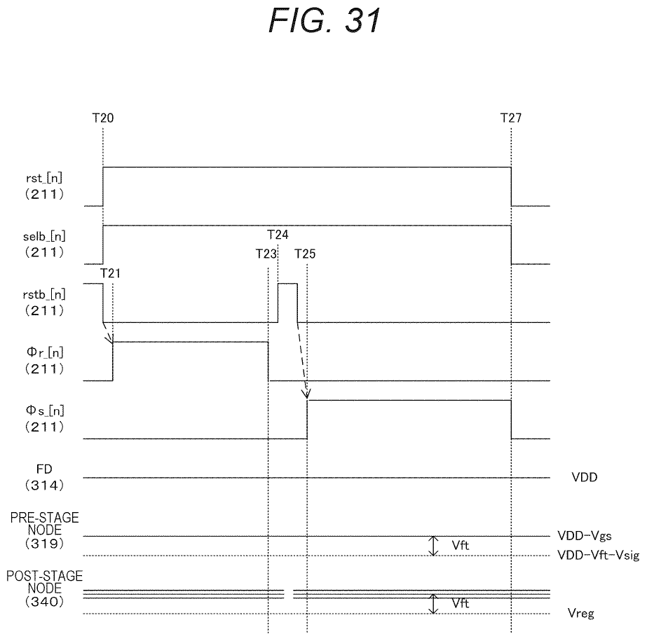

Here, deterioration of the PRNU in the pixels 300 of the first embodiment is discussed with reference to FIGS. 30 and 31. In the first embodiment, as illustrated in an example in FIG. 30, at timing T10 immediately before the start of exposure, the potential of the FD 314 drops due to reset feedthrough of the FD reset transistor 313. The amount of this variation is represented by Vft.

In the first embodiment, the power supply voltage of the FD reset transistor 313 is VDD, and therefore, the potential of the FD 314 varies from VDD to VDD-Vft at timing T10. Furthermore, the potential of the pre-stage node 319 at the time of exposure becomes equal to VDD-Vft-Vsig.

Also, in the first embodiment, as illustrated in an example in FIG. 31, the FD reset transistor 313 shifts to an on-state at the time of reading, and the FD 314 is fixed to the power supply voltage VDD. Due to the amount of variation Vft of the FD 314, the potential of the pre-stage node 319 and the potential of the post-stage node 340 at the time of reading are shifted higher by an amount almost equal to Vft. However, due to variations in the capacitance value of the capacitor elements 321 and 322, or parasitic capacitance, the shift voltage amount varies for each pixel, which causes deterioration of the PRNU.

The amount of shift of the post-stage node 340 in a case where the pre-stage node 319 is shifted by Vft is expressed by the following expression, for example.

$$\{ ( Cs + δ Cs ) / ( Cs + δ Cs + Cp ) \} * Vft \qquad Expession 2$$

In the above expression, Cs represents the capacitance value of the capacitor element 322 on the signal level side, and δCs represents the variation in Cs. Cp represents the capacitance value of the parasitic capacitance of the post-stage node 340.

Expression 2 can be approximated by the following expression.

$$\{ 1 - ( δ Cs / Cs ) * ( Cp / Cs ) \} * Vft \qquad Expession 3$$

According to Expression 3, the variation of the post-stage node 340 can be expressed by the following expression.

$$\{ ( δ Cs / Cs ) * ( Cp / Cs ) \} / Vft \qquad Expession 4$$

With (OCs/Cs) set to 10-2, (Cp/Cs) set to 10-1, and Vft set to 400 millivolts (mV), the PRNU is 400 μVrms according to Expression 4, which is a relatively large value.

In particular, to reduce kTC noise at the time of sampling and holding input conversion capacitance, it is necessary to increase the charge-voltage conversion efficiency of the FD 314. To increase the charge-voltage conversion efficiency, it is necessary to reduce the capacitance of the FD 314. However, the smaller the capacitance of the FD 314, the larger the variation Vft, which may be several hundreds of millivolts (mV). In this case, the influence of the PRNU might become too large to ignore, according to Expression 4.

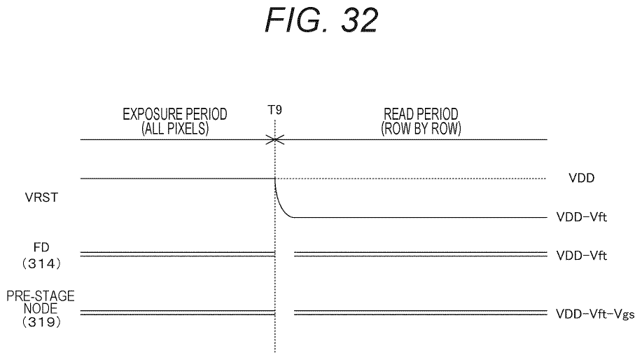

FIG. 32 is a timing chart illustrating an example of voltage control according to the sixth embodiment of the present technology.

The timing control circuit 212 performs control to make the value of the reset power supply voltage VRST for the row-by-row read period after timing T9 different from the reset power supply voltage VRST for the exposure period.

For example, for the exposure period, the timing control circuit 212 sets the reset power supply voltage VRST to the same value as the power supply voltage VDD. For the read period, on the other hand, the timing control circuit 212 lowers the reset power supply voltage VRST to VDD-Vft. That is, for the read period, the timing control circuit 212 lowers the reset power supply voltage VRST by an amount almost equal to the amount of variation Vft caused by reset feedthrough. By this control, the reset level of the FD 314 can be made the same at the time of exposure and at the time of reading.

By controlling the reset power supply voltage VRST, it is possible to reduce the amounts of variation in voltage of the FD 314 and the pre-stage node 319, as illustrated in the example in the drawing. Thus, deterioration of the PRNU due to variations of the capacitor elements 321 and 322 or parasitic capacitance can be prevented.

Note that the first and second modifications of the first embodiment, and the second to fifth embodiments can be applied to the sixth embodiment.

As described above, according to the sixth embodiment of the present technology, the timing control circuit 212 lowers the reset power supply voltage VRST by the amount of variation Vft caused by reset feedthrough at the time of reading, so that the reset level at the time of exposure and the reset level at the time of reading can be made equal to each other. Thus, deterioration of photo response non-uniformity (PRNU) can be prevented.

### 7. Seventh Embodiment

In the first embodiment described above, the reset level and the signal level are read in this order for each frame. With this configuration, however, there is a possibility that photo response non-uniformity (PRNU) will deteriorate due to variations of the capacitor elements 321 and 322 or parasitic capacitance. A solid-state imaging element 200 according to a seventh embodiment differs from that of the first embodiment in that PRNU is improved by switching between the level held in the capacitor element 321 and the level held in the capacitor element 322 for each frame.

The solid-state imaging element 200 according to the seventh embodiment continuously images a plurality of frames in synchronization with a vertical synchronization signal. A frame generated by an odd-numbered exposure operation is referred to as an “odd-numbered frame”, and a frame generated by an even-numbered exposure operation is referred to as an “even-numbered frame”. In the normal mode, odd-numbered frames and even-numbered frames are alternately generated. In the gain switching mode, on the other hand, in a case where gains are switched in M stages, M odd-numbered frames and M even-numbered frames are alternately generated.

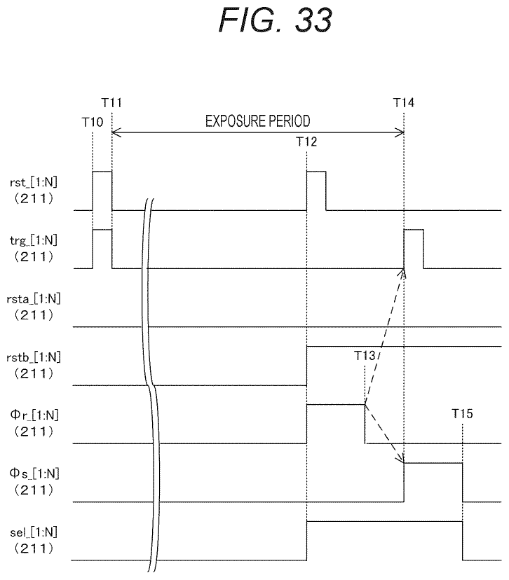

FIG. 33 is a timing chart illustrating an example of a global shutter operation for an odd-numbered frame according to the seventh embodiment of the present technology. The pre-stage circuit 310 in the solid-state imaging element 200 sets the selection signal or and the selection signal Φs to the high level in this order within the exposure period for the odd-numbered frame, to cause the capacitor element 321 to hold the reset level and then cause the capacitor element 322 to hold the signal level.

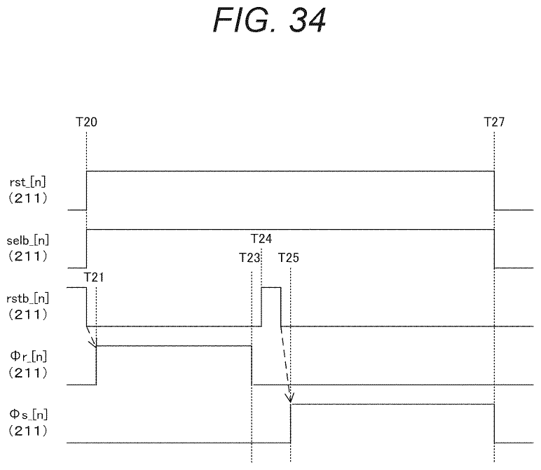

FIG. 34 is a timing chart illustrating an example of a read operation for an odd-numbered frame according to the seventh embodiment of the present technology. The post-stage circuit 350 in the solid-state imaging element 200 sets the selection signal or and the selection signal Φs to the high level in this order, to read the reset level and the signal level in this order within the read period for the odd-numbered frame.

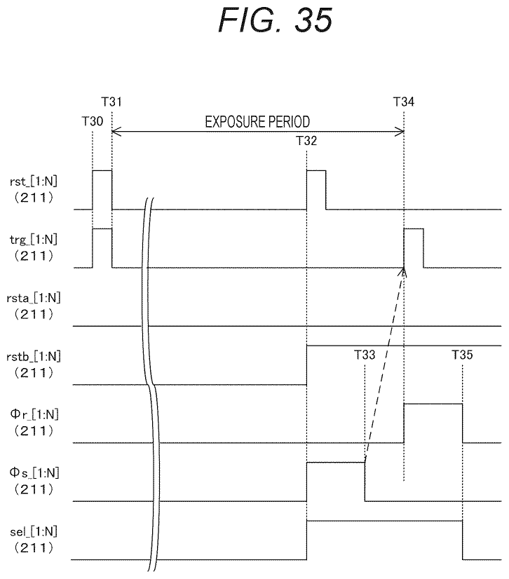

FIG. 35 is a timing chart illustrating an example of a global shutter operation for an even-numbered frame according to the seventh embodiment of the present technology. The pre-stage circuit 310 in the solid-state imaging element 200 sets the selection signal Φs and the selection signal Ør to the high level in this order within the exposure period for the even-numbered frame, to cause the capacitor element 322 to hold the reset level and then cause the capacitor element 321 to hold the signal level.

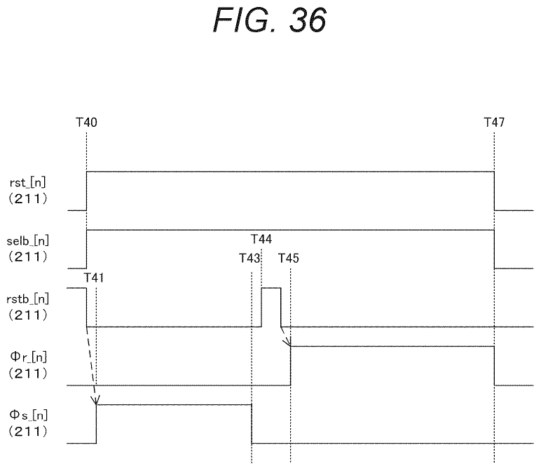

FIG. 36 is a timing chart illustrating an example of a read operation for an even-numbered frame according to the seventh embodiment of the present technology. The post-stage circuit 350 in the solid-state imaging element 200 sets the selection signal Φs and the selection signal Ør to the high level in this order, to read the reset level and the signal level in this order within the read period for the even-numbered frame.

As illustrated as an example in FIGS. 33 and 35, the levels held in the capacitor elements 321 and 322 are reversed between the even-numbered frame and the odd-numbered frame. This also reverses the polarities of the PRNUs of the even-numbered frame and the odd-numbered frame. The column signal processing circuit 260 in the subsequent stage obtains an arithmetic mean of the odd-numbered frame and the even-numbered frame. Thus, the PRNUs with opposite polarities can cancel out each other.

This control is effective in capturing a moving image or adding up frames. Furthermore, there is no need to add any element to the pixels 300, and this control can be realized only by changing the drive system.

Note that the first and second modifications of the first embodiment, and the second to sixth embodiments can be applied to the seventh embodiment.

As described above, in the seventh embodiment of the present technology, the level held in the capacitor element 321 and the level held in the capacitor element 322 are reversed between an odd-numbered frame and an even-numbered frame, and accordingly, the polarities of the PRNUs can be reversed between the odd-numbered frame and the even-numbered frame. The column signal processing circuit 260 adds up the odd-numbered frames and the even-numbered frames, so that deterioration of the PRNU can be prevented.

### 8. Eighth Embodiment

In the first embodiment described above, the column signal processing circuit 260 obtains a difference between the reset level and the signal level for each column. In this configuration, however, there is a possibility that, when light with a very high intensity enters a pixel, a black spot phenomenon in which black spots appear will occur due to a luminance drop caused by overflow of electric charge from the photoelectric conversion element 311. A solid-state imaging element 200 according to an eighth embodiment differs from that of the first embodiment in determining whether or not the black spot phenomenon has occurred for each pixel.

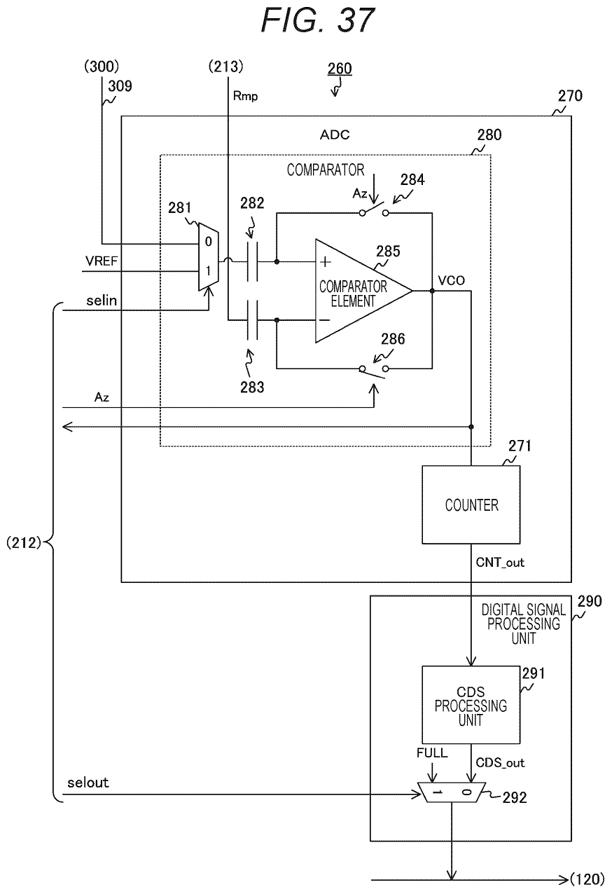

FIG. 37 is a circuit diagram illustrating an example configuration of the column signal processing circuit 260 according to the eighth embodiment of the present technology. In the column signal processing circuit 260 according to the eighth embodiment, a plurality of ADCs 270 and a digital signal processing unit 290 are disposed. Furthermore, in the digital signal processing unit 290, a plurality of CDS processing units 291 and a plurality of selectors 292 are disposed. The ADCs 270, the CDS processing units 291, and the selectors 292 are provided for the respective columns.

Furthermore, the ADCs 270 each include a comparator 280 and a counter 271. The comparator 280 compares the level of the vertical signal line 309 with the ramp signal Rmp from the DAC 213, and outputs a comparison result VCO. The comparison result VCO is supplied to the counter 271 and the timing control circuit 212. The comparator 280 includes a selector 281, capacitor elements 282 and 283, auto-zero switches 284 and 286, and a comparator element 285. In a case where analog gains of the ADCs 270 are switched, a capacitance ratio switching circuit 510 may be provided instead of the capacitor elements 282 and 283, or the fluctuation velocity of the ramp signal is only required to be changed.

The selector 281 connects either the vertical signal line 309 of the corresponding column or a node of a predetermined reference voltage VREF to a non-inverting input terminal (+) of the comparator element 285 via the capacitor element 282, in accordance with an input-side selection signal selin. The input-side selection signal selin is supplied from the timing control circuit 212.

The comparator element 285 compares the level of the non-inverting input terminal (+) with the level of an inverting input terminal (−), and outputs the comparison result VCO to the counter 271. The ramp signal Rmp is input to the inverting input terminal (−) via the capacitor element 283.

The auto-zero switch 284 short-circuits the non-inverting input terminal (+) and an output terminal of the comparison result VCO, in accordance with an auto-zero signal Az from the timing control circuit 212. The auto-zero switch 286 short-circuits the inverting input terminal (−) and the output terminal of the comparison result VCO, in accordance with the auto-zero signal Az.

The counter 271 counts a count value over the period until the comparison result VCO is inverted, and outputs a digital signal CNT_out indicating the count value to the CDS processing unit 291.

The CDS processing unit 291 performs a CDS process on the digital signal CNT_out. The CDS processing unit 291 calculates a difference between the digital signal CNT_out corresponding to the reset level and the digital signal CNT_out corresponding to the signal level, and outputs the difference as CDS_out to the selector 292.

The selector 292 outputs, in accordance with an output-side selection signal selout from the timing control circuit 212, either the digital signal CDS_out subjected to the CDS process or a full-code digital signal FULL as pixel data of the corresponding column.

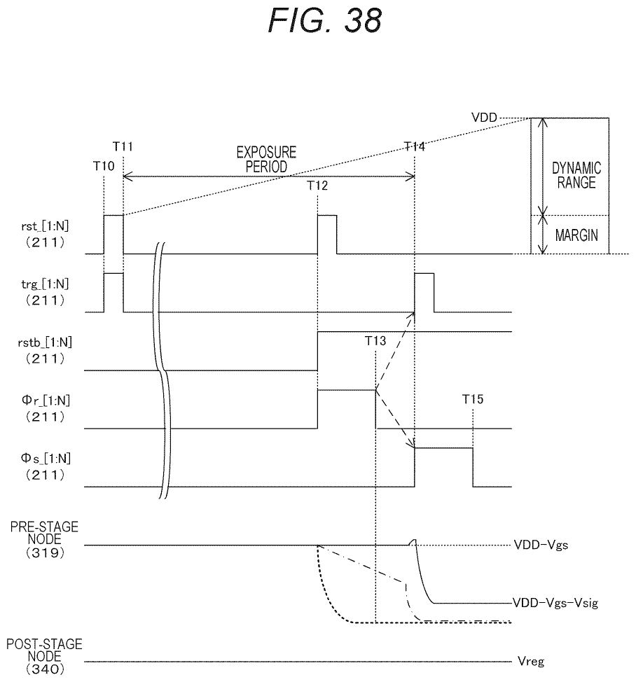

FIG. 38 is a timing chart illustrating an example of a global shutter operation according to the eighth embodiment of the present technology. The method for controlling the transistors at the time of global shutter according to the eighth embodiment is similar to that of the first embodiment.

Here, it is assumed that light with a very high intensity enters the pixel 300. In this case, the photoelectric conversion element 311 becomes full of electric charge, and the electric charge overflows from the photoelectric conversion element 311 into the FD 314, resulting in a decrease in the potential of the FD 314 subjected to the FD reset. A dot-and-dash line in the drawing indicates the variation in the potential of the FD 314 when weak sunlight that causes a relatively small amount of electric charge to overflow enters. A dotted line in the drawing indicates the variation in the potential of the FD 314 when strong sunlight that causes a relatively large amount of electric charge to overflow enters.

When weak sunlight enters, the reset level is dropping at timing T13 that is the end of the FD reset, but the level has not fully dropped at this point of time.

When strong sunlight enters, on the other hand, the reset level has fully dropped at timing T13. In this case, the signal level becomes the same as the reset level, and the potential difference between the signal level and the reset level is “0”. Therefore, the digital signal subjected to the CDS process becomes the same as a digital signal in a dark state and sinks in black. A phenomenon in which the pixel turns black as described above even though light with a very high intensity such as sunlight has entered is called a black spot phenomenon or blooming.

Furthermore, when the level of the FD 314 of the pixel in which the black spot phenomenon has occurred becomes too low, the operating point of the pre-stage circuit 310 cannot be secured, and the current id1 of the current source transistor 316 fluctuates accordingly. The current source transistor 316 of each pixel is connected to a common power supply or the ground. Therefore, when the current fluctuates in a pixel, the variation in the IR drop in the pixel affects the sample levels of the other pixels. The pixel in which the black spot phenomenon has occurred turns into an aggressor, and a pixel whose the sample level has fluctuated due to the pixel having the black spot phenomenon turns into a victim. As a result, streaking noise appears.

Note that, in a case where the discharge transistor 317 is provided as in the fifth embodiment, in the pixel having black spots (blooming), overflowing electric charge is discarded on the side of the discharge transistor 317, and therefore, the black spot phenomenon is less likely to occur. However, even if the discharge transistor 317 is provided, part of the electric charge might flow into the FD 314, and there is a possibility that the black spot phenomenon will not completely be avoided. Moreover, there is also a disadvantage that the ratio of the effective area/the charge amount in each pixel becomes lower due to the addition of the discharge transistor 317. In view of this, it is desirable to prevent the black spot phenomenon, without using the discharge transistor 317.

As the methods for preventing the black spot phenomenon without the use of the discharge transistor 317, there are two possible methods. The first one is adjustment of the clip level of the FD 314. The second one is a method by which whether or not the black spot phenomenon has occurred at a time of reading is determined, and, when the black spot phenomenon has occurred, the output is replaced with a full code.

As for the first method, the high level of the FD reset signal rst (in other words, the gate of the FD reset transistor 313) in the drawing corresponds to the power supply voltage VDD, and the low level corresponds to the clip level of the FD 314. In the first embodiment, a difference between the high level and the low level (which is the amplitude) is set to the value corresponding to the dynamic range. In the eighth embodiment, on the other hand, the value is adjusted to a value plus an additional margin. Here, the value corresponding to the dynamic range corresponds to the difference between the power supply voltage VDD and the potential of the FD 314 when the digital signal is a full code.

By lowering the gate voltage (the low level of the FD reset signal rst) when the FD reset transistor 313 is off, it is possible to prevent the FD 314 from becoming too low due to blooming, and the operating point of the pre-stage amplification transistor 315 from being lost.

Note that the dynamic range varies depending on the analog gain of the ADC. When the analog gain is low, the dynamic range needs to be wide. When the analog gain is high, on the other hand, the dynamic range can be narrow. Accordingly, it is possible to change the gate voltage when the FD reset transistor 313 is off, in accordance with the analog gain.

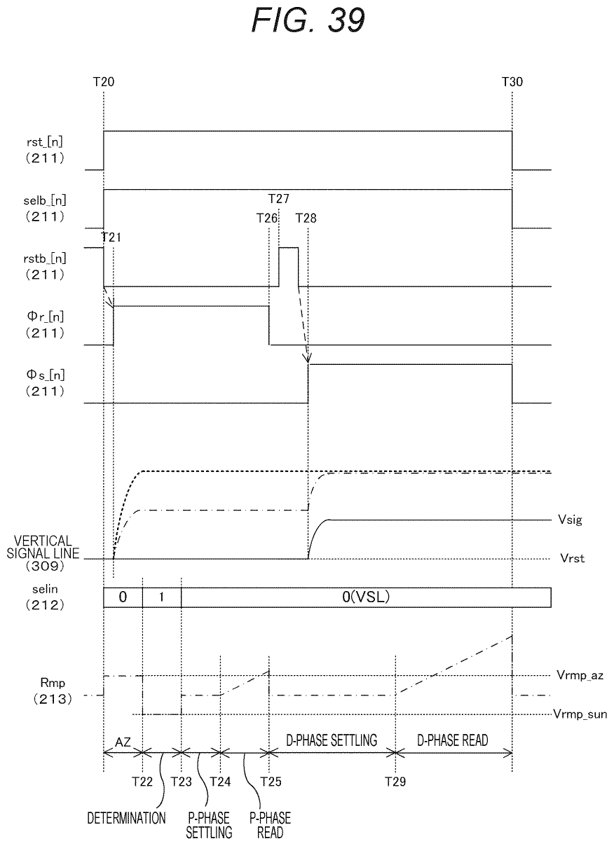

FIG. 39 is a timing chart illustrating an example of a read operation according to the eighth embodiment of the present technology. When the selection signal Ør switches to the high level at timing T21 immediately after timing T20 that is the start of reading, the potential of the vertical signal line 309 fluctuates in a pixel that sunlight has entered. A dot-and-dash line in the drawing indicates the variation in the potential of the vertical signal line 309 when weak sunlight has entered. A dotted line in the drawing indicates the variation in the potential of the vertical signal line 309 when strong sunlight has entered.

In the auto-zero period from timing T20 to timing T22, the timing control circuit 212 supplies the input-side selection signal selin of “0”, for example, to connect the comparator element 285 to the vertical signal line 309. Within this auto-zero period, the timing control circuit 212 performs auto-zeroing using the auto-zero signal Az.

As for the second method, the timing control circuit 212 supplies the input-side selection signal selin of “1”, for example, within the determination period from timing T22 to timing T23. With the input-side selection signal selin, the comparator element 285 is disconnected from the vertical signal line 309, and is connected to the node of the reference voltage VREF. The reference voltage VREF is set to the expected value of the level of the vertical signal line 309 when blooming does not occur. Where the gate-source voltage of the post-stage amplification transistor 351 is represented by Vgs2, for example, Vrst corresponds to Vreg-Vgs2. Furthermore, the DAC 213 lowers the level of the ramp signal Rmp from Vrmp_az to Vrmp_sun within the determination period.

Furthermore, in a case where blooming does not occur within the determination period, the reset level Vrst of the vertical signal line 309 is almost the same as the reference voltage VREF, and is not much different from when the potential of the inverting input terminal (+) of the comparator element 285 is auto-zero. On the other hand, the non-inverting input terminal (−) has dropped from Vrmp_az to Vrmp_sun, and therefore, the comparison result VCO switches to the high level.

Conversely, in a case where blooming has occurred, the reset level Vrst becomes sufficiently higher than the reference voltage VREF, and the comparison result VCO switches to the low level when the following expression is satisfied.

$$Vrst - VREF > Vrmp\_az - Vrmp\_sun \qquad Expession 5$$

That is, the timing control circuit 212 can determine whether or not blooming has occurred, on the basis of whether or not the comparison result VCO switches to the low level within the determination period.

Note that it is necessary to secure a relatively large margin for sunlight determination (the right side of Expression 5) so as to prevent erroneous determination due to variation in the threshold voltage of the post-stage amplification transistor 351, IR drop differences in the in-plane Vreg, or the like.

After timing T23 after the end of the determination period, the timing control circuit 212 connects the comparator element 285 to the vertical signal line 309. Furthermore, after the P-phase settling period from timing T23 to timing T24 has passed, the P-phase is read within the period from timing T24 to timing T25. After the D-phase settling period from timing T25 to timing T29 has passed, the D-phase is read within the period from timing T29 to timing T30.

In a case where the timing control circuit 212 determines that blooming has not occurred over the determination period, the timing control circuit 212 controls the selector 292 with the output-side selection signal selout, to output the digital signal CDS_out subjected to the CDS process without any change.

In a case where the timing control circuit 212 determines that blooming has occurred over the determination period, on the other hand, the timing control circuit 212 controls the selector 292 with the output-side selection signal selout, to output the full code FULL, instead of the digital signal CDS_out subjected to the CDS process. Thus, the black spot phenomenon can be prevented.

Note that the first and second modifications of the first embodiment, and the second to seventh embodiments can also be applied to the eighth embodiment.

As described above, according to the eighth embodiment of the present technology, the timing control circuit 212 determines whether or not the black spot phenomenon has occurred on the basis of the comparison result VCO, and outputs a full code when the black spot phenomenon has occurred. Thus, the black spot phenomenon can be prevented.

### 9. Ninth Embodiment

In the first embodiment described above, the vertical scanning circuit 211 performs control to expose all the rows (all the pixels) at the same time (which is a global shutter operation). However, in a case where simultaneity of exposure is not required, but low noise is required, such as when a test or analysis is conducted, it is desirable to perform a rolling shutter operation. A solid-state imaging element 200 according to a ninth embodiment differs from that of the first embodiment in performing the rolling shutter operation at a time of a test or the like.

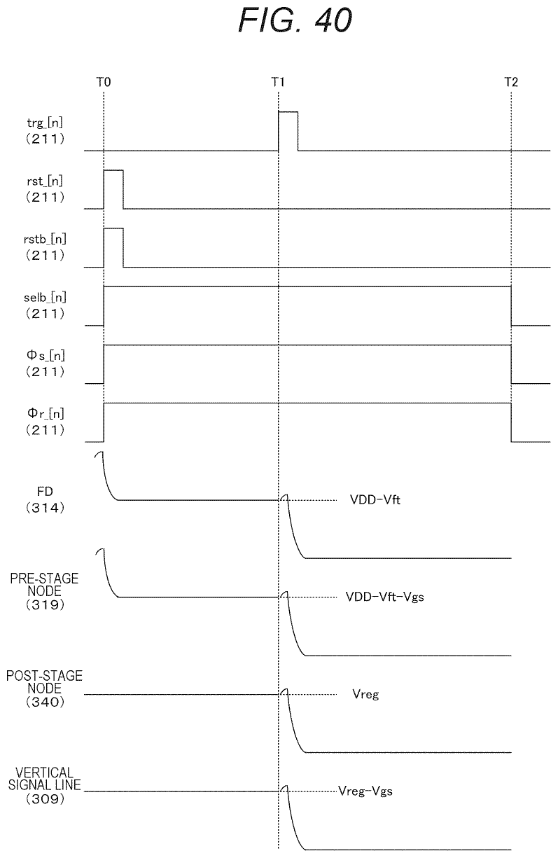

FIG. 40 is a timing chart illustrating an example of the rolling shutter operation according to the ninth embodiment of the present technology. The vertical scanning circuit 211 performs control to sequentially select a plurality of rows and start exposure. This drawing illustrates exposure control for the n-th row.

Over the period from timing T0 to timing T2, the vertical scanning circuit 211 supplies the high-level post-stage selection signal selb, the high-level selection signal or, and the high-level selection signal Øs to the n-th row. Furthermore, at timing TO that is the start of exposure, the vertical scanning circuit 211 supplies the high-level FD reset signal rst and the high-level post-stage reset signal rstb to the n-th row over the pulse period. At timing T1 that is the end of the exposure, the vertical scanning circuit 211 supplies the transfer signal trg to the n-th row. The rolling shutter operation in the drawing allows the solid-state imaging element 200 to generate low-noise image data.

Note that, in the normal mode and the gain switching mode, the solid-state imaging element 200 of the ninth embodiment performs the global shutter operation in a manner similar to that in the first embodiment.

Furthermore, the first and second modifications of the first embodiment, and the second to eighth embodiments can also be applied to the ninth embodiment. As described above, according to the ninth embodiment of the present technology, the vertical scanning circuit 211 performs control to sequentially select a plurality of rows and start exposure (which is the rolling shutter operation), and thus, low-noise image data can be generated.

### 10. Tenth Embodiment

In the first embodiment described above, the source of the pre-stage source follower (the pre-stage amplification transistor 315 and the current source transistor 316) is connected to the power supply voltage VDD, and row-by-row reading is performed while the source follower is in an on-state. By this drive method, however, there is a possibility that the circuit noise of the pre-stage source follower at the time of row-by-row reading will propagate to the subsequent stages, and random noise will increase accordingly. A solid-state imaging element 200 according to a tenth embodiment differs from that of the first embodiment in that the pre-stage source follower is put into an off-state at the time of reading, to reduce noise.

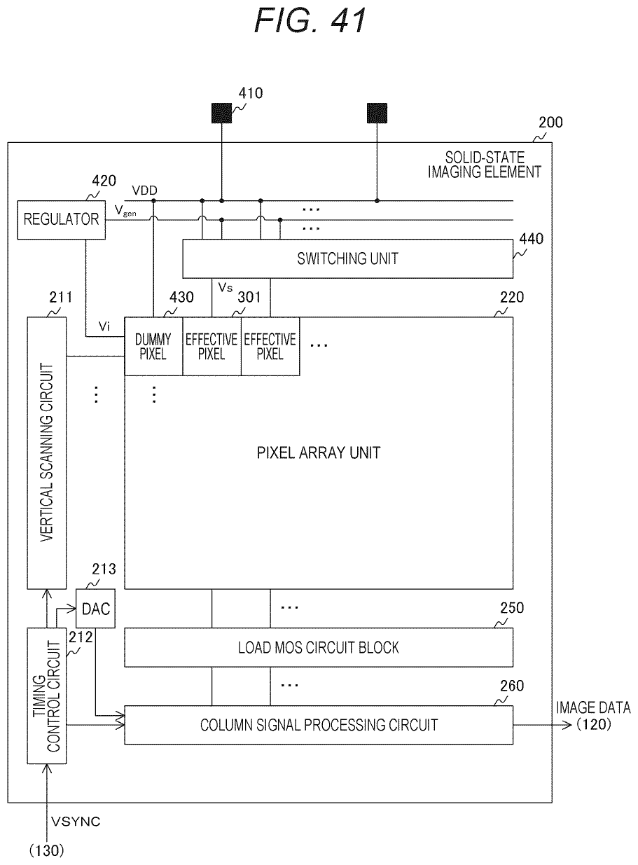

FIG. 41 is a block diagram illustrating an example configuration of the solid-state imaging element 200 according to the tenth embodiment of the present technology. The solid-state imaging element 200 of the tenth embodiment differs from that of the first embodiment in further including a regulator 420 and a switching unit 440. Furthermore, in the pixel array unit 220 of the tenth embodiment, a plurality of effective pixels 301 and a predetermined number of dummy pixels 430 are arrayed. The dummy pixels 430 are arranged around the region in which the effective pixels 301 are arrayed.

Furthermore, the power supply voltage VDD is supplied to each of the dummy pixels 430, and the power supply voltage VDD and a source voltage Vs are supplied to each of the effective pixels 301. The signal lines for supplying the power supply voltage VDD to the effective pixels 301 are not shown in the drawing. Furthermore, the power supply voltage VDD is supplied from a pad 410 located outside the solid-state imaging element 200.

The regulator 420 generates a constant generation voltage Vgen on the basis of an input voltage Vi from the dummy pixels 430, and supplies the generation voltage Vgen to the switching unit 440. The switching unit 440 selects either the power supply voltage VDD from the pad 410 or the generation voltage Vgen from the regulator 420, and supplies the selected voltage as the source voltage Vs to each of the columns of the effective pixels 301.

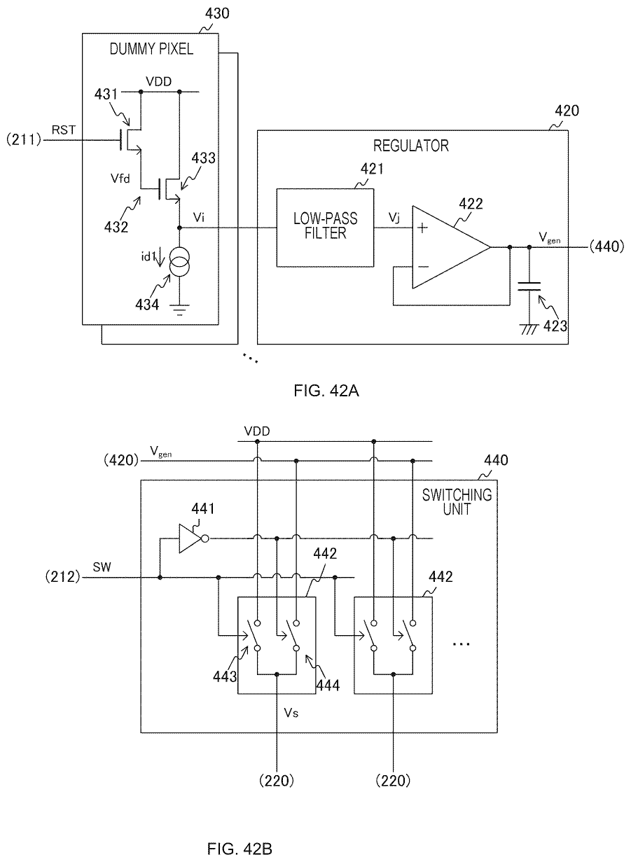

FIG. 42 is a circuit diagram illustrating an example configuration of a dummy pixel 430, the regulator 420, and the switching unit 440 according to the tenth embodiment of the present technology. In the drawing, a indicates circuit diagrams of the dummy pixel 430 and the regulator 420, and b indicates a circuit diagram of the switching unit 440.

As illustrated as an example in a in the drawing, the dummy pixel 430 includes a reset transistor 431, an FD 432, an amplification transistor 433, and a current source transistor 434. The reset transistor 431 initializes the FD 432, in accordance with a reset signal RST from the vertical scanning circuit 211. The FD 432 accumulates electric charge, and generates a voltage corresponding to the charge amount. The amplification transistor 433 amplifies the level of the voltage of the FD 432, and supplies the amplified voltage as the input voltage Vi to the regulator 420.

Furthermore, the reset transistor 431 and the amplification transistor 433 have their respective sources connected to the power supply voltage VDD. The current source transistor 434 is connected to the drain of the amplification transistor 433. The current source transistor 434 supplies the current id1, under the control of the vertical scanning circuit 211.

The regulator 420 includes a low-pass filter 421, a buffer amplifier 422, and a capacitor element 423. The low-pass filter 421 passes, as an output voltage Vj, a component in a low-frequency band below a predetermined frequency out of a signal of the input voltage Vi.

The output voltage Vj is input to a non-inverting input terminal (+) of the buffer amplifier 422. An inverting input terminal (−) of the buffer amplifier 422 is connected to an output terminal thereof. The capacitor element 423 holds a voltage of the output terminal of the buffer amplifier 422 as Vgen. This Vgen is supplied to the switching unit 440.

As illustrated as an example in b of the drawing, the switching unit 440 includes an inverter 441 and a plurality of switching circuits 442. The switching circuits 442 are provided for the respective columns of the effective pixels 301.

The inverter 441 inverts a switching signal SW supplied from the timing control circuit 212. The inverter 441 supplies the inverted signal to each of the switching circuits 442.

The switching circuits 442 each select either the power supply voltage VDD or the generation voltage Vgen, and supplies the selected voltage as the source voltage Vs to the corresponding column in the pixel array unit 220. The switching circuits 442 each include switches 443 and 444. The switch 443 opens and closes a path between the node of the power supply voltage VDD and the corresponding column, in accordance with the switching signal SW. The switch 444 opens and closes a path between the node of the generation voltage Vgen and the corresponding column, in accordance with an inverted signal of the switching signal SW.

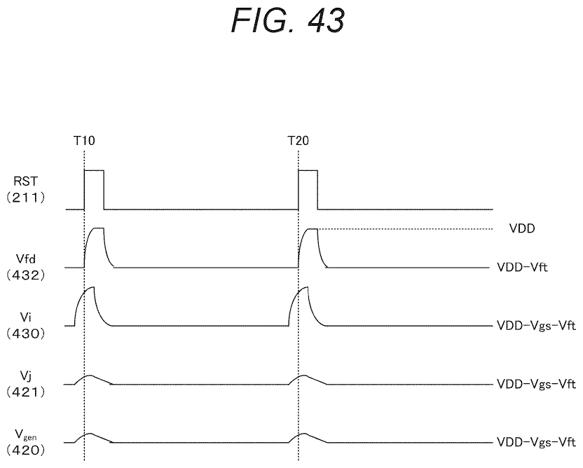

FIG. 43 is a timing chart illustrating an example of operations of the dummy pixels 430 and the regulator 420 according to the tenth embodiment of the present technology. At timing T10 immediately before reading of a certain row, the vertical scanning circuit 211 supplies a high-level reset signal RST (the power supply voltage VDD herein) to each of the dummy pixels 430. A potential Vfd of the FD 432 in each dummy pixel 430 is initialized to the power supply voltage VDD. Further, when the reset signal RST switches the low level, reset feedthrough causes a change to VDD-Vft.

Furthermore, the input voltage Vi drops to VDD-Vgs-Vsig after the reset. Passing through the low-pass filter 421, Vj and Vgen turn into voltages that are almost constant.

After timing T20 immediately before reading of the next row, similar control is performed for each row, and the constant generation voltage Vgen is supplied.

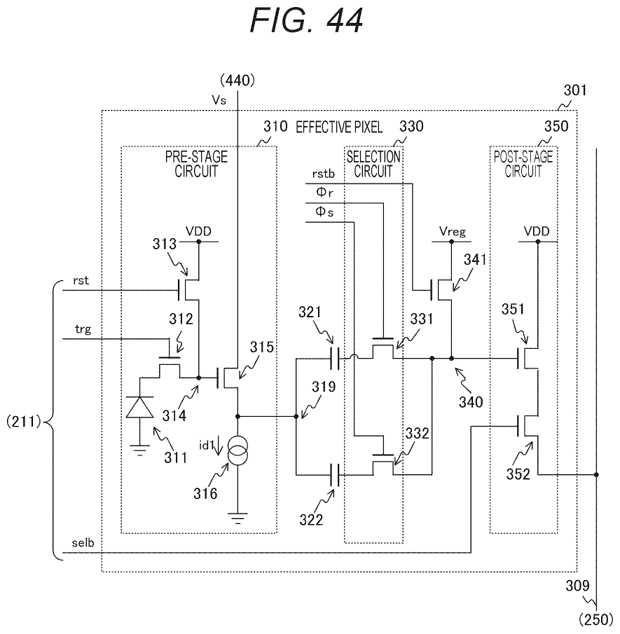

FIG. 44 is a circuit diagram illustrating an example configuration of an effective pixel 301 according to the tenth embodiment of the present technology. The effective pixel 301 is similar in circuit configuration to each pixel 300 of the first embodiment, except that the source voltage Vs from the switching unit 440 is supplied to the source of the pre-stage amplification transistor 315.

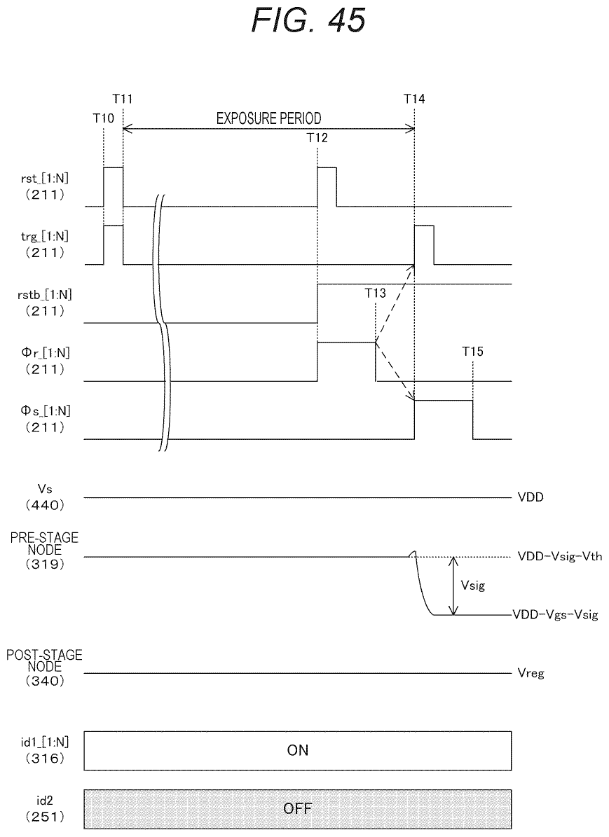

FIG. 45 is a timing chart illustrating an example of a global shutter operation according to the tenth embodiment of the present technology. In the tenth embodiment, when all the pixels are exposed simultaneously, the switching unit 440 selects the power supply voltage VDD, and supplies the power supply voltage VDD as the source voltage Vs. Furthermore, the voltage of the pre-stage node drops from VDD-Vgs-Vth to VDD-Vgs-Vsig at timing T14. Here, Vth represents a threshold voltage of the transfer transistor 312.

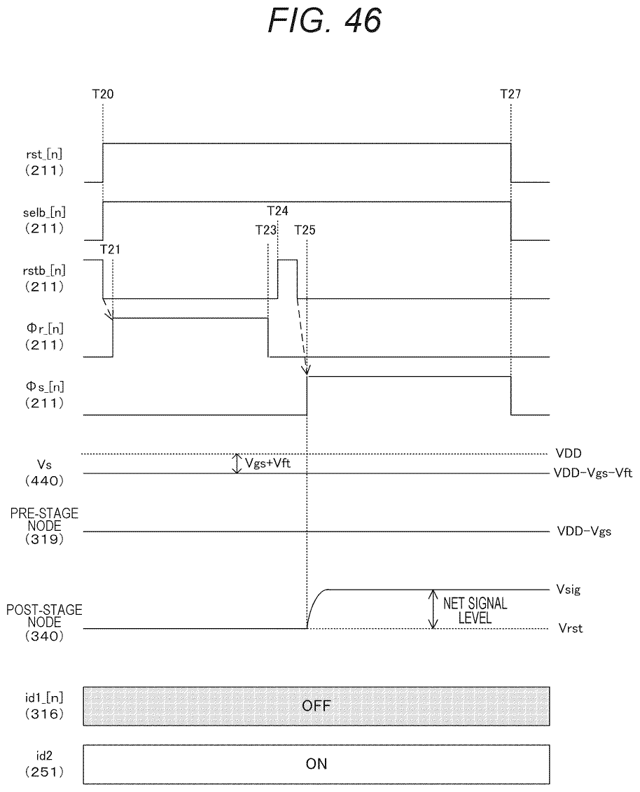

FIG. 46 is a timing chart illustrating an example of a read operation according to the tenth embodiment of the present technology. In the tenth embodiment, at the time of reading, the switching unit 440 selects the generation voltage Vgen, and supplies the selected voltage as the source voltage Vs. The generation voltage Vgen is adjusted to VDD-Vgs-Vft. Furthermore, in the tenth embodiment, the vertical scanning circuit 211 controls the current source transistors 316 of all the rows (all the pixels) to stop the supply of the current id1.

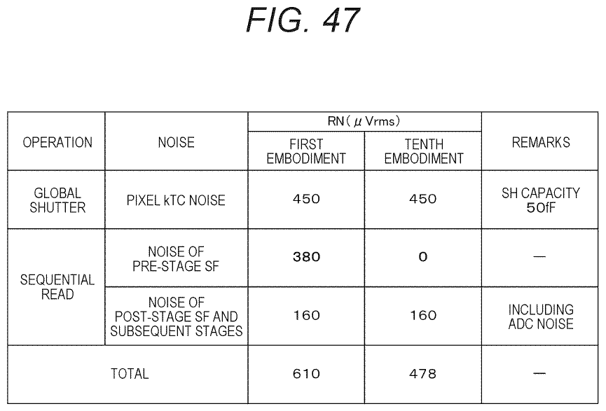

FIG. 47 is a table for explaining the effects of the tenth embodiment of the present technology. In the first embodiment, the source follower (the pre-stage amplification transistor 315 and the current source transistor 316) of the pixel 300 to be read is turned on during row-by-row reading. By this drive method, however, there is a possibility that the circuit noise of the pre-stage source follower will propagate to the subsequent stages (the capacitor elements, and post-stage source follower and ADCs), and readout noise will increases accordingly.

For example, in the first embodiment, the kTC noise to be generated in a pixel during the global shutter operation is 450 (μVrms) as shown as an example in the table. Furthermore, the noise to be generated in the pre-stage source follower (the pre-stage amplification transistor 315 and the current source transistor 316) during row-by-row reading is 380 (μVrms). The noise to be generated in the prost-stage source follower and the subsequent stages is 160 (μVrms). Accordingly, the total noise is 610 (μVrms). As described above, in the first embodiment, the proportion of the noise of the pre-stage source follower in the total noise is relatively large.

To reduce the noise of the pre-stage source follower in the tenth embodiment, the voltage (Vs) that can be adjusted is supplied to the source of the pre-stage source follower as described above. During the global shutter (exposure) operation, the switching unit 440 selects the power supply voltage VDD, and supplies the selected power supply voltage as the source voltage Vs. Further, after the end of the exposure, the switching unit 440 switches the source voltage Vs to VDD-Vgs-Vft. Furthermore, the timing control circuit 212 turns on the pre-stage current source transistor 316 during the global shutter (exposure) operation, and turns off the pre-stage current source transistor 316 after the end of the exposure.

As illustrated as an example in FIGS. 45 and 46, by the above-described control, the potential of the pre-stage node during the global shutter operation and the potential during the row-by-row reading can be made identical to each other, and thus, the PRNU can be improved. Furthermore, the pre-stage source follower is in an off-state during the row-by-row reading. Accordingly, any circuit noise of the source follower does not appear, and the circuit noise is 0 (μVrms) as illustrated as an example in FIG. 47. Note that, in the pre-stage source follower, the pre-stage amplification transistor 315 is in an on-state.

Note that the first and second modifications of the first embodiment, and the second to ninth embodiments can also be applied to the tenth embodiment.

As described above, according to the tenth embodiment of the present technology, the pre-stage source follower is put into an off-state at a time of reading, and thus, the noise to be generated in the source follower can be reduced.

### 11. Examples of Applications to Mobile Objects

The technology according to the present disclosure (the present technology) can be applied to various products. For example, the technology according to the present disclosure may be embodied as a device mounted on any type of mobile objects such as an automobile, an electric vehicle, a hybrid electric vehicle, a motorcycle, a bicycle, a personal mobility, an airplane, a drone, a ship, a robot, and the like.

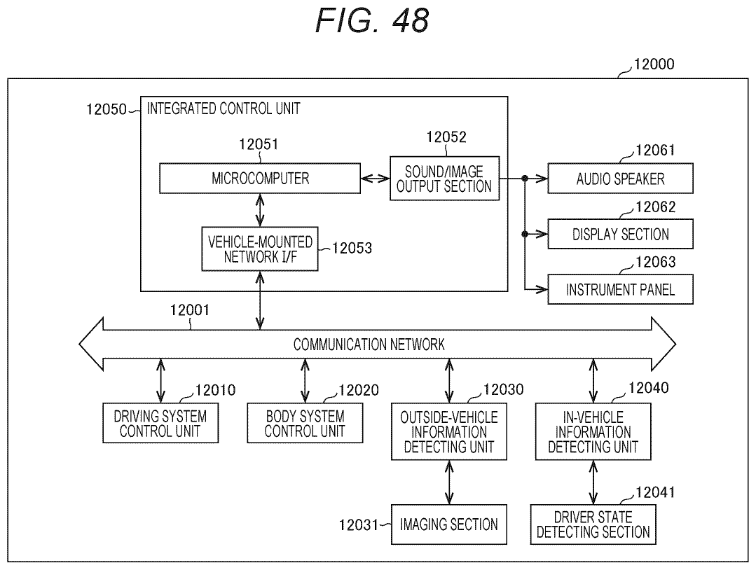

FIG. 48 is a block diagram illustrating an example of a schematic configuration of a vehicle control system as an example of a mobile object control system to which the technology according to the present disclosure can be applied.

The vehicle control system 12000 includes a plurality of electronic control units connected to each other via a communication network 12001. In the example illustrated in FIG. 48, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as functional components of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Also, the microcomputer 12051 can output a control command to the body system control unit 12020, on the basis of information about the outside of the vehicle, which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example in FIG. 48, an audio speaker 12061, a display section 12062, and an instrument panel 12063 are illustrated as output devices. The display section 12062 may, for example, include at least one of an on-board display and a head-up display.

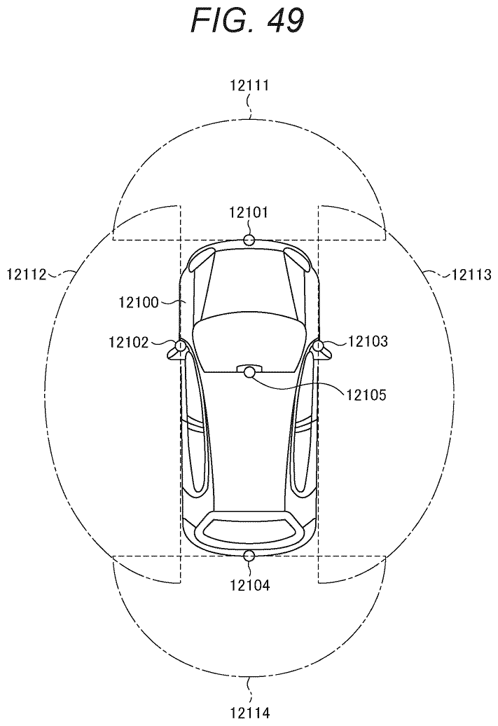

FIG. 49 is a diagram illustrating an example of installation positions of the imaging section 12031.

In FIG. 49, the imaging section 12031 includes imaging sections 12101, 12102, 12103, 12104, and 12105.

The imaging sections 12101, 12102, 12103, 12104, and 12105 are provided at positions such as the front nose, the sideview mirrors, the rear bumper, the back doors, and an upper portion of the windshield in the interior of a vehicle 12100, for example. The imaging section 12101 provided to the front nose and the imaging section 12105 provided to the upper portion of the windshield within the interior of the vehicle obtain mainly an image of the front of the vehicle 12100. The imaging sections 12102 and 12103 provided on the sideview mirrors obtain mainly images of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 49 illustrates an example of the imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 among the components described above. Specifically, the imaging device 100 in FIG. 1 can be applied to the imaging section 12031, for example. By applying the technology according to the present disclosure to the imaging section 12031, it is possible to perform imaging with a plurality of gains, and obtain a plurality of captured images that vary in brightness.

Note that the embodiments described above show examples for embodying the present technology, and the matters in the embodiments and the matters specifying the invention in the claims have correspondence relationships, respectively. Likewise, the matters specifying the invention in the claims and the matters with the same names in the embodiments of the present technology have correspondence relationships, respectively. However, the present technology is not limited to the embodiments, and can be embodied by applying various modifications to the embodiments without departing from the scope of the present technology.

Note that the effects described in the present specification are merely examples and are not limited, and other effects may also be achieved.

Note that the present technology may also have the following configurations.

(1) A solid-state imaging element including:
a pre-stage circuit that generates a pixel signal;
a sample-and-hold circuit that holds the pixel signal over a predetermined holding period, and outputs the pixel signal a plurality of times within the holding period;
an amplifier circuit that amplifies the pixel signal with a gain designated by a predetermined control signal among a plurality of gains; and
a timing control circuit that sequentially designates the plurality of gains with the control signal within the holding period.

(2) The solid-state imaging element according to (1), in which

the amplifier circuit includes a comparator that compares the pixel signal with a predetermined ramp signal.

(3) The solid-state imaging element according to (2), in which
the pre-stage circuit and the sample-and-hold circuit are disposed in a pixel, and
the comparator includes:
a differential amplifier circuit that amplifies a difference between a predetermined reference voltage and a voltage of a predetermined node, and outputs the difference as a comparison result;
a vertical-signal-line-side capacitor that is inserted between the predetermined node and a vertical scanning line to which the pixel is connected;
a ramp-side capacitor that is inserted between the predetermined node and a digital-to-analog converter that generates the ramp signal; and
a switch that changes a capacitance ratio between the vertical-signal-line-side capacitor and the ramp-side capacitor, in accordance with the control signal.

(4) The solid-state imaging element according to (2), further including
a digital-to-analog converter that generates the ramp signal in accordance with the control signal,
in which the timing control circuit changes a velocity at which the level of the ramp signal fluctuates, using the control signal.

(5) The solid-state imaging element according to (1), further including
an analog-to-digital converter that performs an analog-to-digital conversion process on the pixel signal,
in which the amplifier circuit includes a column amplifier that supplies the amplified pixel signal to the analog-to-digital converter.

(6) The solid-state imaging element according to (1), further including
a post-stage circuit that supplies the pixel signal to a vertical signal line,
in which the amplifier circuit supplies the amplified pixel signal to the post-stage circuit.

(7) The solid-state imaging element according to (1), further including
an analog-to-digital converter that performs an analog-to-digital conversion process on the pixel signal,
in which the amplifier circuit amplifies the pixel signal subjected to the analog-to-digital conversion process.

(8) The solid-state imaging element according to any one of (1) to (7), further including
a post-stage reset transistor,
in which
the sample-and-hold circuit includes:
first and second capacitor elements; and
a selection circuit that sequentially performs control to connect one of the first and second capacitor elements to a predetermined post-stage node, control to disconnect both the first and second capacitor elements from the post-stage node, and control to connect another one of the first and second capacitor elements to the post-stage node, and
the post-stage reset transistor initializes the level of the post-stage node when both the first and second capacitor elements are disconnected from the post-stage node.

(9) An imaging device including:
a pre-stage circuit that generates a pixel signal;
a sample-and-hold circuit that holds the pixel signal over a predetermined holding period, and outputs the pixel signal a plurality of times within the holding period;
an amplifier circuit that amplifies the pixel signal with a gain designated by a predetermined control signal among a plurality of gains;
a timing control circuit that sequentially designates the plurality of gains with the control signal within the holding period; and
a digital signal processing circuit that processes image data in which the pixel signals are arrayed.

(10) The imaging device according to (9), further including
a set value holding unit that holds a value of one gain of the plurality of gains as a set value, in accordance with an operation by a user,
in which the amplifier circuit amplifies the pixel signal with a gain of the set value.

(11) The imaging device according to (9), in which the digital signal processing circuit performs machine learning, using a predetermined number of pieces of the image data.

(12) A method for controlling a solid-state imaging element, the method including:
a pre-stage step of generating a pixel signal;
a sample-and-hold step of holding the pixel signal over a predetermined holding period, and outputting the pixel signal a plurality of times within the holding period;
an amplifying step of amplifying the pixel signal with a gain designated by a predetermined control signal among a plurality of gains; and
a timing control step of sequentially designating the plurality of gains with the control signal within the holding period.

### REFERENCE SIGNS LIST

100 Imaging device
110 Optical unit
120 DSP circuit
121 Data set generation unit
122 Data set holding unit
123 Machine learning unit
124 Learning result holding unit
125 Image recognition unit
126 Image processing unit
130 Display unit
140 Operation unit
150 Bus
160 Frame memory
170 Storage unit
180 Power supply unit
200 Solid-state imaging element
201 Upper pixel chip
202 Lower pixel chip
203 Circuit chip
211 Vertical scanning circuit
212 Timing control circuit
213 DAC
214 Set value holding unit
220 Pixel array unit
221 Upper pixel array unit
222 Lower pixel array unit
250 Load MOS circuit block
251 Load MOS transistor
260 Column signal processing circuit
261 Column amplifier
270 ADC
271 Counter
280, 500 Comparator
281, 292 Selector
282, 283, 321, 322, 423 Capacitor element
284, 286 Auto-zero switch
285 Comparator element
290 Digital signal processing unit
291 CDS processing unit
293 Multiplier
294 Post-stage processing unit
300 Pixel
301 Effective pixel
310 Pre-stage circuit
311 Photoelectric conversion element
312 Transfer transistor
313 FD reset transistor
314, 432 FD
315 Pre-stage amplification transistor
316 Current source transistor
317 Discharge transistor
320 Sample-and-hold circuit
323 Pre-stage reset transistor
324 Pre-stage selection transistor
330 Selection circuit
331, 332 Selection transistor
341 Post-stage reset transistor
350, 350-1, 350-2 Post-stage circuit
351, 351-1, 351-2 Post-stage amplification transistor
352, 352-1, 352-2 Post-stage selection transistor
360 Amplifier circuit
361 Resistor
362 Variable resistor
363, 531, 532 pMOS transistor
364, 533 to 535 nMOS transistor
420 Regulator
421 Low-pass filter
422 Buffer amplifier
430 Dummy pixel
431 Reset transistor
433 Amplification transistor
434 Current source transistor
440 Switching unit
441 Inverter
442 Switching circuit
443, 444, 511 to 515 Switch
510 Capacitance ratio switching circuit
516 to 521, 540 Capacitor
530 Differential amplifier circuit
536, 537 Auto-zero switch
12031 Imaging section

1. A solid-state imaging element comprising:
a pre-stage circuit that generates a pixel signal;
a sample-and-hold circuit that holds the pixel signal over a predetermined holding period, and outputs the pixel signal a plurality of times within the holding period;
an amplifier circuit that amplifies the pixel signal with a gain designated by a predetermined control signal among a plurality of gains; and
a timing control circuit that sequentially designates the plurality of gains with the control signal within the holding period.

2. The solid-state imaging element according to claim 1, wherein
the amplifier circuit includes a comparator that compares the pixel signal with a predetermined ramp signal.

3. The solid-state imaging element according to claim 2, wherein
the pre-stage circuit and the sample-and-hold circuit are disposed in a pixel, and
the comparator includes:
a differential amplifier circuit that amplifies a difference between a predetermined reference voltage and a voltage of a predetermined node, and outputs the difference as a comparison result;
a vertical-signal-line-side capacitor that is inserted between the predetermined node and a vertical scanning line to which the pixel is connected;
a ramp-side capacitor that is inserted between the predetermined node and a digital-to-analog converter that generates the ramp signal; and
a switch that changes a capacitance ratio between the vertical-signal-line-side capacitor and the ramp-side capacitor, in accordance with the control signal.

4. The solid-state imaging element according to claim 2, further comprising
a digital-to-analog converter that generates the ramp signal in accordance with the control signal,
wherein the timing control circuit changes a velocity at which the level of the ramp signal fluctuates, using the control signal.

5. The solid-state imaging element according to claim 1, further comprising
an analog-to-digital converter that performs an analog-to-digital conversion process on the pixel signal,
wherein the amplifier circuit includes a column amplifier that supplies the amplified pixel signal to the analog-to-digital converter.

6. The solid-state imaging element according to claim 1, further comprising
a post-stage circuit that supplies the pixel signal to a vertical signal line,
wherein the amplifier circuit supplies the amplified pixel signal to the post-stage circuit.

7. The solid-state imaging element according to claim 1, further comprising
an analog-to-digital converter that performs an analog-to-digital conversion process on the pixel signal,
wherein the amplifier circuit amplifies the pixel signal subjected to the analog-to-digital conversion process.

8. The solid-state imaging element according to claim 1, further comprising
a post-stage reset transistor,
wherein
the sample-and-hold circuit includes:
first and second capacitor elements; and
a selection circuit that sequentially performs control to connect one of the first and second capacitor elements to a predetermined post-stage node, control to disconnect both the first and second capacitor elements from the post-stage node, and control to connect another one of the first and second capacitor elements to the post-stage node, and
the post-stage reset transistor initializes a level of the post-stage node when both the first and second capacitor elements are disconnected from the post-stage node.

9. An imaging device comprising:
a pre-stage circuit that generates a pixel signal;
a sample-and-hold circuit that holds the pixel signal over a predetermined holding period, and outputs the pixel signal a plurality of times within the holding period;
an amplifier circuit that amplifies the pixel signal with a gain designated by a predetermined control signal among a plurality of gains;
a timing control circuit that sequentially designates the plurality of gains with the control signal within the holding period; and
a digital signal processing circuit that processes image data in which the pixel signals are arrayed.

10. The imaging device according to claim 9, further comprising
a set value holding unit that holds a value of one gain of the plurality of gains as a set value, in accordance with an operation by a user,
wherein the amplifier circuit amplifies the pixel signal with a gain of the set value.

11. The imaging device according to claim 9, wherein
the digital signal processing circuit performs machine learning, using a predetermined number of pieces of the image data.

12. A method for controlling a solid-state imaging element, the method comprising:
a pre-stage step of generating a pixel signal;
a sample-and-hold step of holding the pixel signal over a predetermined holding period, and outputting the pixel signal a plurality of times within the holding period;
an amplifying step of amplifying the pixel signal with a gain designated by a predetermined control signal among a plurality of gains; and
a timing control step of sequentially designating the plurality of gains with the control signal within the holding period.
